(19) United States
(12) Patent Application Publication
(10) Pub. No.: US 2011/0154229 A1
(43) Pub. Date: Jun. 23, 2011

(54) MOSAIC IDENTITY

(75) Inventors: James E. Allard, Seattle, WA (US); Douglas C. Hebenthal, Redmond, WA (US)

(73) Assignee: MICROSOFT CORPORATION, Redmond, WA (US)

(21) Appl. No.: 12/641,122

(22) Filed: Dec. 17, 2009

(51) Int. Cl. G05B 19/00; G06F 3/048

(52) U.S. Cl. 715/764; 340/5.8

(57) ABSTRACT

Techniques are disclosed herein for adapting user interaction with resources to facets of the user's identity. A user has multiple facets of their identity such as parent, employee, gamer and coach. The active facet of the user's identity may impact how the user interacts with resources when using their electronic devices. For example, the computing resources to which a user has access may be influenced by whether the user is acting as a parent or employee. A system is provided that adapts how the user interacts with resources available to a user based on one or more facets of the user's identity that are active at the particular time. The system may tailor search results to the active facet of the user's identity, provide product recommendations that are specific to the active facet the user's identity, etc.

### BACKGROUND

Each individual person has many different facets to their identity that may correspond to different areas of their lives, such as their career, family, hobbies, etc. People tend to behave and think differently depending on which facet of their identity they are currently assuming For example, a person's mood, mode of talking, interests, etc. may be different based on whether they are working or with the family. Also, their interests may change depending on what activities they are engaged in, where they are, time of day, day of the week, etc.

Technology has advanced such that people have access to many different resources through an ever increasing set of electronic devices. For example, many people can access their work documents, personal documents, the Internet and other resources through their work computer, home desktop computer, laptop computer, cell phone, Internet enabled television, and other appliances. In some cases, a user can access all of their available resources at all times of the day. However, always accessing all resources in the same manner may be inefficient and cause security issues.

### SUMMARY

A user has multiple facets of their identity such as parent, employee, gamer, coach, tourist, etc. Technology is disclosed for adapting a user's experience when interacting with a variety of resources. The adaptation is based on the active facet of the user's identity at the time the user is interacting with the resource. In this manner, the user will be able to access the user's resources via multiple devices, with the experience customized based on the facet of their identity that is currently active.

The currently active facet of the user's identity may impact the user's experience when using their electronic devices to interact with one or more resources. For example, the computing resources to which a user has access may be influenced by whether the user is acting as a parent or employee, how the user interacts with others through the user's electronic devices may be influenced by the facet of the user's identity that is current active (e.g., is the user acting as a Dad, an employee, a coach, etc.), and search results/advertisements/product recommendations can be tailored to the facet of the user's identity that is current active. Other interactions with resources can also be customized.

One embodiment includes a machine implemented method that comprises receiving a request associated with a resource with which a user wishes to interact. The request is received at a first electronic device from a second electronic device. A facet of the user's identity that is currently active is determined based on one or more environment conditions. The adaptation of user interaction with the resource is provided for based on the facet that is currently active.

One embodiment includes a machine implemented method that comprises the following. A request for user identity information that is specific to an active facet of a user's identity is electronically sent from a first electronic device to a second electronic device. A set of user identity information that is specific to the active facet of the of user's identity is received at the first electronic device in response to the request. User interaction with a resource with which the user is interacting with at the first electronic device is adapted based on the set of user identity information that is specific to the active facet of the user's identity.

One embodiment includes a computer system comprising a processor and one or more computer readable storage devices coupled to the processor. The one or more computer readable storage devices have stored thereon instructions which when executed on the processor cause the processor to perform the following. The processor receives user identity information from a plurality of host devices, different portions of the user identity information are specific to different facets of a user's identity. The processor stores the user identity information from each of the plurality of host devices in the one or more computer readable storage devices, different potions of the stored user identity information are associated with different facets of a user's identity. The processor electronically receives, from either a first of the host devices or an electronic device that is being accessed by the first host device, a request for user identity information that is specific to an active facet of the user's identity. The processor determines a facet of a user's identity that is active at the time the request is received based on one or more environment conditions. The processor forms a set of user identity information from the stored user identity information, at least a portion of the set of user identity information is specific to the facet that is determined to be active. The processor sends the set of user identity information to either the first of the host devices or the electronic device that is being accessed by the first host device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram representing one embodiment of system for adapting user interaction with resources based on a currently active facet of the user's identity.

FIG. 1B is a flowchart illustrating one embodiment of a process for adapting user interaction with resources based on a currently active facet of their identity.

FIG. 2A is a block diagram of one embodiment of an architecture system for establishing user identity information for facets of a user's identity.

FIG. 2B is a block diagram of one embodiment of a system for establishing user identity information for facets of a user's identity.

FIG. 2C is a flowchart illustrating one embodiment of a process for establishing user identity information for facets of a user's identity.

FIG. 2D is a flowchart illustrating one embodiment of a process for a host device accessing user identity information for a currently active facet of the user's identity.

FIG. 2E is a flowchart of one embodiment of a process of a host device making a resource request.

FIG. 3A is a block diagram of one embodiment of an architecture for responding to requests from host devices based on an active facet of a user's identity.

FIG. 3B is a block diagram of one embodiment of a system for responding to requests from host devices based on an active facet of a user's identity.

FIG. 3C is a flowchart illustrating one embodiment of a process for responding to requests from host devices based on an active facet of a user's identity.

FIG. 4A is a block diagram of one embodiment of an architecture for responding to requests from host devices based on an active facet of a user's identity.

FIG. 4B is a block diagram of one embodiment of a system for responding to requests from host devices based on an active facet of a user's identity.

FIG. 4C is a flowchart illustrating one embodiment of a process for responding to requests from host devices based on an active facet of a user's identity.

FIG. 5A is a flowchart illustrating one embodiment of a process of host devices providing baseline user identity information.

FIG. 5B is a flowchart illustrating one embodiment of a process for confirming baseline user identity information.

FIG. 5C is a flowchart illustrating one embodiment of a process for providing user identity information.

FIG. 6 is a flowchart illustrating one embodiment of a process for determining an active facet of the user's identity.

FIG. 7 is a flowchart illustrating one embodiment of a process for a user establishing an active facet of the user's identity.

FIG. 8 is a flowchart illustrating one embodiment of a process for a host device determining an active facet of the user's identity.

FIG. 9 is a flowchart illustrating one embodiment of a process for an authentication and authorization server controlling access to a resource based on a currently active facet of the user's identity.

FIG. 10A is a flowchart illustrating an embodiment of a process of a host device adapting user interaction with a resource based on a currently active facet of the user's identity.

FIG. 10B is a flowchart illustrating an embodiment of a process of a host device adapting user interaction with a resource based on a currently active facet of the user's identity.

FIG. 10C is a flowchart of one embodiment of a search engine adapting search results to an active facet of the user's identity.

FIG. 10D is a flowchart of one embodiment of an e-commerce web site adapting a user's experience on the web site to an active facet.

FIG. 11 depicts an example computer system that serves as a platform for embodiments.

FIG. 12 shows functional components of a handheld computing device that serves as a platform for embodiments.

FIG. 13 shows an example configuration of a computer that serves as a platform for embodiments.

### DETAILED DESCRIPTION

Technology is disclosed for adapting a user's experience when accessing a variety of resources. The adaptation is based on the active facet of the user's identity at the time the user is interacting with the resource. Examples of resources include data, files, services available via a network, electronic devices, etc. Adapting a user's experience when interacting with a resource includes determining, changing and enforcing what resources are available to a user, how the resources function, and how the resources are presented. For example, determining which resources a user has access to (via a network or via an electronic device), how the user interacts with others through the user's electronic devices, how the user is identified to others, how others are identified to the user, how the user's electronic device operates, the performance of services (e.g., search, advertisement and/or recommendation engines), etc. can all be customized based on the facet of the user's identity that is current active (e.g., is the user acting as a Dad, an employee, a coach, etc.). The technology described herein is not limited to any set of facets of a user's identity or any set or resources.

A user may have many electronic devices that can communicate on the cloud (e.g., the Internet or other network). Typically, the user may use multiple devices throughout the day, week, or year to access the user's data and services. Based on various environment conditions, the facet of the user's identity that is currently active can be automatically determined by anyone of many computing devices in the system so that the user's computing devices, data, services and/or other resources can be adapted in response thereto. Thus, the appropriate set of data and services will be available to the user at the appropriate times. Examples of environment conditions include the device currently being used by the user, one or more previous devices used, time of day, day of the week, season, weather, observed behavior of the user, location of the user, data interacted with, etc. No specific environment condition is required for the technology described here.

In one embodiment, a user need only authenticate once, with any one device, and the user will have access to multiple devices, resources, domains, etc., customized in response to the facet of the user's identity that is currently active.

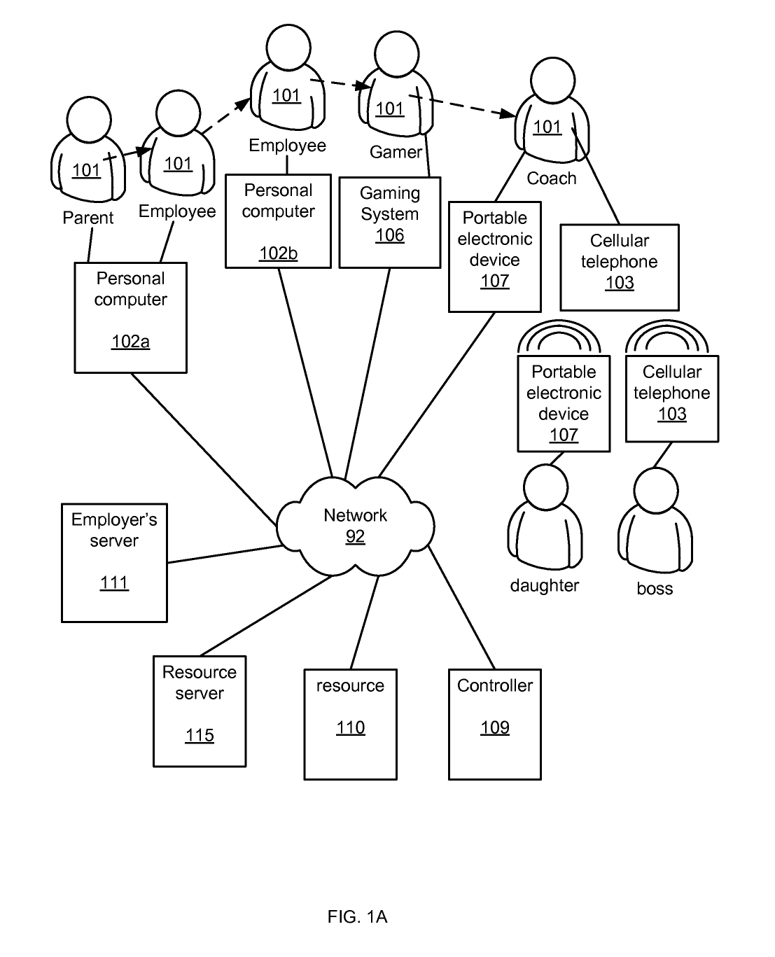

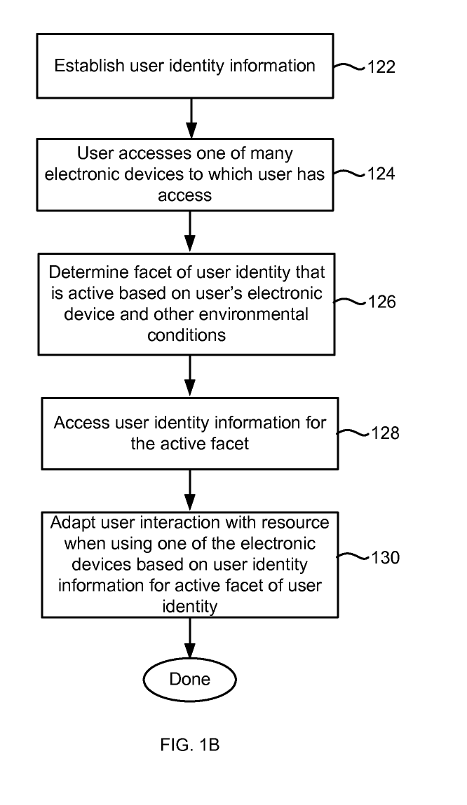

FIG. 1A is a block diagram representing one embodiment of system for adapting a user's interaction with resources when using and/or accessing various electronic devices based on a currently active facet of the user's identity. The user 101 has a variety of electronic devices that are connected to a controller 109 by network 92. Network 92 may be implemented by one or more networks such as, but not limited to, the Internet, a local area network (LAN), wide area network (WAN), Virtual Private Network (VPN). The various user electronic devices may include, but are not limited to, personal computers 102a, 102b, game system 106, portable electronic device 107, and cellular telephone 103. Network 92 also allows the user 101 to use one of their electronic devices to connect to employer's server 111 or the resource server 115. For example, the resource server 115 might host a search engine or e-commerce web site. The servers 111, 115 might provide access to a resource 110, such documents, search results, product recommendations, etc. Others, such as the user's daughter and boss have their own electronic devices such as cellular telephones 103 and portable electronic devices 107. Such other electronic devices may communicate with one of the user's electronic devices via a cellular telephone network or other network.

The following hypothetical will be used to show the system adapting to changes in the facets of the user's identity that are active. When the user 101 gets up in the morning, the user 101 accesses their home personal computer 102a to check their personal emails, perform web searches, or visit an e-commerce web site. At this time, the active facet of the user's identity may be the parent facet, spouse facet, or perhaps a personal facet. The user may then log into their employer's server 111 via network 92 from the personal computer 102a in order to work from home. When logging in to the employer's server 111 from home, the active facet of the user's identity is now in the employee facet.

To adapt to changes in the facet of the user's identity that is currently active, the system may adapt the user's interaction with resources 110 based on the currently active facet of the user's identity. For example, the resources 110 to which the user 101 is entitled may be different based on whether the facet of the user's identity that is currently active is a parent or employee facet. As another example, if the user is performing a search using a search engine, the search results provided to the user can be tailored so that when the user is acting as a parent, the user 101 may see a different set of search results than when the user is acting as an employee. Similarly, user 101 will see one set of product or service recommendations when the user is acting as a parent and another set of product or service recommendations when acting as an employee. As another example, settings on a word processor application that is used to edit a document can be tailored to the currently active facet of the user's identity. Note that the facet of the user's identity that is active may change even though the user 101 has not changed electronic devices.

Continuing on with the user's day, the user 101 then goes to work and accesses resources (e.g., documents) from a computer 102b at work. At this time, the user 101 is acting as an employee and the system will adapt the word processor, other applications and various application settings to the employee facet of the user's identity. However, if the user 101 accesses a personal document from their work computer 102b, then the system might adapt the word processor settings to the personal facet. At the end of the workday, the user 101 goes home and logs onto a game system 106. At this time, the active facet of the user's identity is that of a “gamer.” When the user 101 is acting as a gamer, others who are in the online game environment might know the user 101 as an enthusiast of one or more online games, but might not know anything about the other facets of the user's identity. For example, other users have no idea what type of work the user 101 engages in. Likewise, profile information linked to other facets such as parent and employee facets might have no indication of the user's interest in electronic games. Thus, only those who know the user 101 through the gamer facet of the user's identity would be provided with the user's “gamer identity” (e.g., avatar) and/or a means to contact the user 101 to discuss electronic games (e.g., through a gamer forum). Thus, when the user is acting as a gamer, the system adapts to how others know the user 101 and how the user interacts with others. If the user 101 decides to place an electronic transaction to make a purchase when acting as a gamer, the system might ask the user 101 if the user desires to make the purchase with a credit card on file for the gamer facet. On the other hand, if the user makes a purchase of office products at 11 AM on a Tuesday, the system may determine that the user is acting as an employee and ask the user if they user wished to pay for the purchase using the user's company issued credit card.

The system can also know of the existence of other facets of the user's identity to the benefit of the user. For example, the system might not have any credit card information on file for the gamer facet of the user's identity. However, the system might know that the user 101 has credit card information on file for a parent facet of the user's identity. The system may ask the user 101 if the user desires to make the purchase, while acting as a gamer, using the credit card information on file for the parent facet of the user's identity. Thus, information associated with some of the facets of the user's identity may have certain commonalities. In this case, the commonalty is the same credit card/billing information.

Continuing with the user's day, the user 101 subsequently coaches soccer for the user's child's team and, thus, the active facet of the user's identity is a “coach” facet. When acting as a coach, the user 101 might receive phone calls from their spouse and/or their boss. Because the user 101 is not acting as an employee, they might wish to avoid taking the call from their boss. However, the user 101 might wish to always take a telephone call from their spouse. So, the user's cell phone may send the boss' call directly to voicemail and have the spouse's call ring on the loudest volume. If the call from the boss came during work hours, it may be put through with a loud and special ring tone. Therefore, the system is able to control communication between the user 101 and others based on the currently active facet of the user's identity.

In some embodiments, one or more electronic devices in the system have software that is used to adapt the user's interaction with resources to the facet of the user's identity that is currently active. In one embodiment, the controller 109 has software thereon which adapts the user's interaction with resources based on the facet of the user's identity that is currently active. Note that the controller 109 may be implemented by one or more servers or other electronic devices. Software running on the one or more servers might be used to control access to a resource that is requested by the user 101 or to adapt the user's interaction with the resource in some other manner. The software on the controller 109 might also provide information to other electronic devices that can be used to adapt the user's interaction with resources to the facet of the user's identity that is currently active. For example, the controller 109 might send information to the resource server 115, which itself runs software to adapt the user's interaction with resources to the facet of the user's identity that is currently active. As a specific example, a search engine could run software that adapts search results for the user 101 to the facet of the user's identity that is currently active. The user's electronic devices may also have software thereon which adapts the user's interaction with resources to the facet of the user's identity that is currently active. Thus, the software that adapts the user's interaction with resources to the facet of the user's identity that is currently active may reside on a wide variety of electronic devices. However, note that it is not required that all of these electronic devices have special software for adapting the user's interaction with resources to the of the user's identity that is currently active.

FIG. 1B is a flowchart illustrating one embodiment of a process for adapting a user's interaction with resources when accessing various electronic devices based on a currently active facet of the user's identity. In one embodiment, the system of FIG. 1A is used to implement the process of FIG. 1B. For example, software running on the controller 109, servers 111, 115, and/or any of the user's electronic devices 102a, 102b, 103, 106, 107 may implement one or more steps of the process.

In step 122, user identity information is established. User identity information may include baseline identity information and facet specific identity information. The baseline identity information is information about the user that may be pertinent to more than one facet of the user's identity such as a user name, email address, credit card information, etc. The facet specific identity information is information about the user that is typically specific to the one facet the user's identity. For example, the user 101 may have a user name that is used only in the game environment or profile information (e.g., likes/dislikes) that is specific to the game environment.

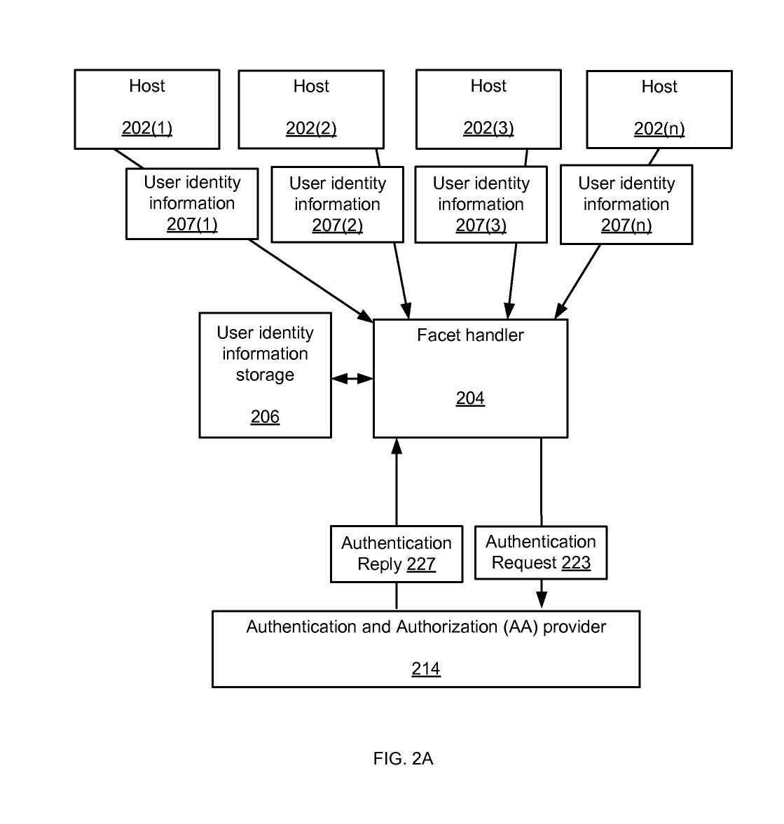

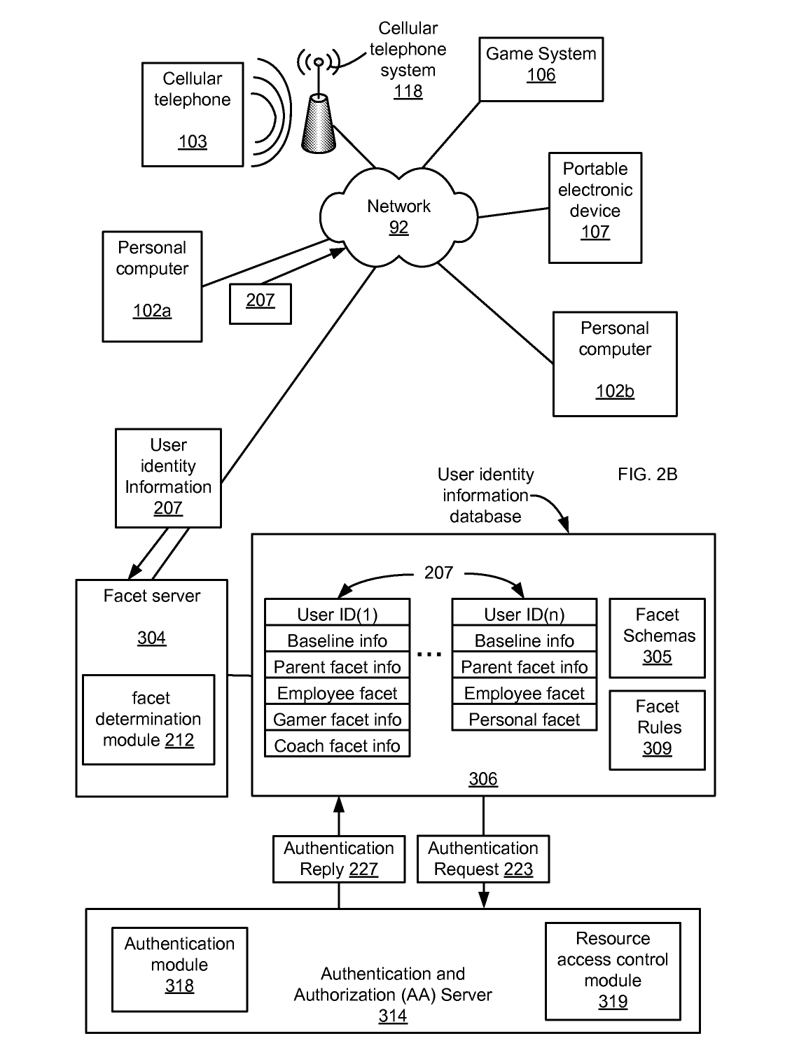

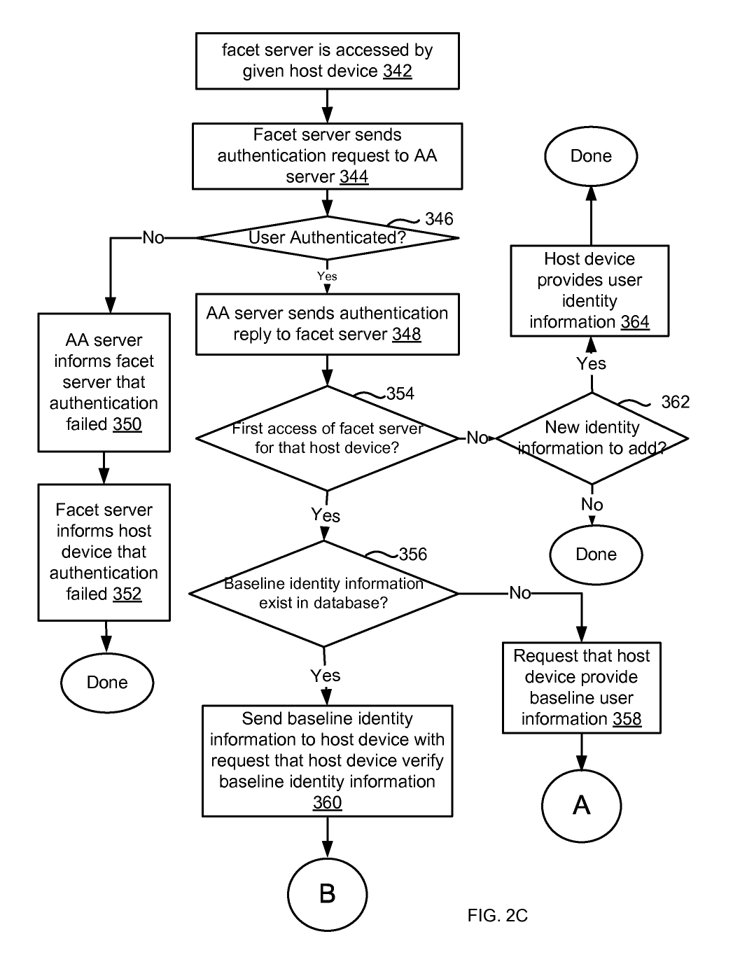

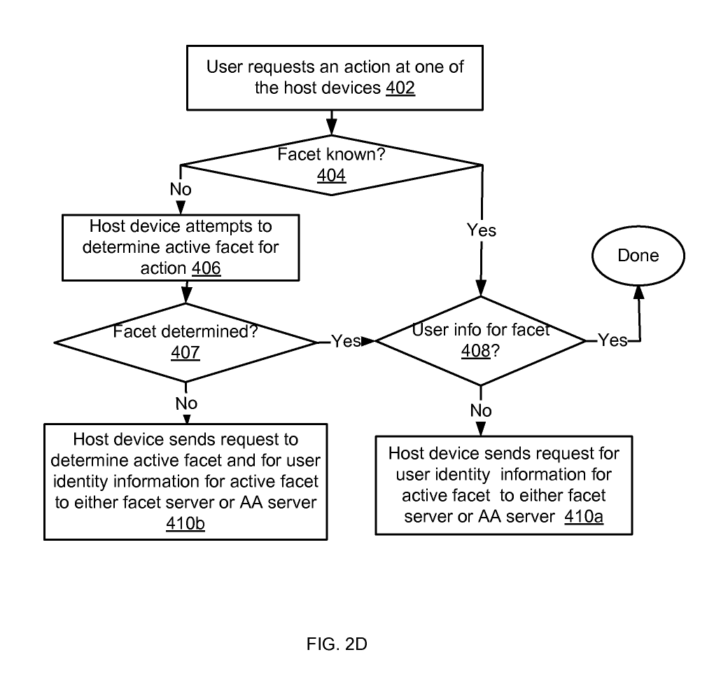

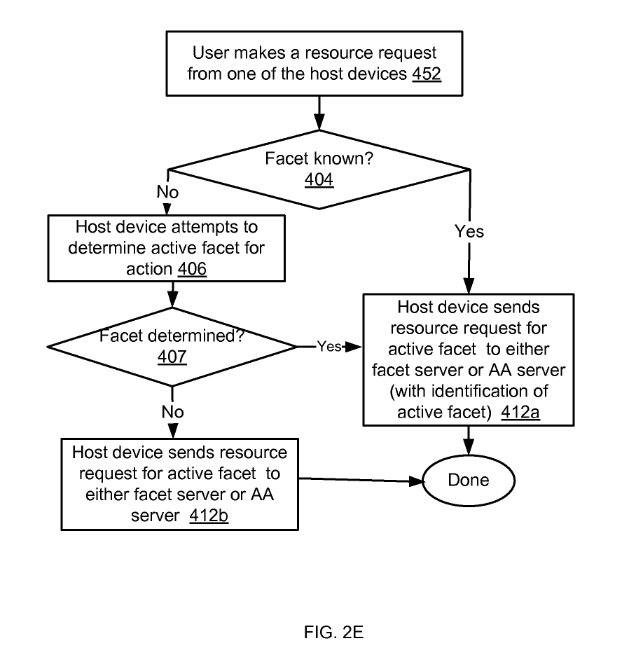

The following example of establishing user identity information is presented for illustration. When the user 101 first logs into the game system 106, the game system requests that the user 101 provide baseline identity information such as a user name, email address, credit card information, etc. The game system 106 may also request the user 101 provide information that is specific to the gamer facet. The game system 106 may provide this user identity information to controller 109 such that controller may be accessed by the user 101 through a different electronic device. When the user 101 logs in to other electronic devices, those electronic devices may also collect user identity information, which may be provided to controller 109. Further details of establishing user identity information are discussed in connection with FIGS. 2A-2C.

In step 124, the user 101 accesses one of the electronic devices to which the user has access. For example, the user turns on and possibly logs in to their home computer 102a, work computer 102b, portable electronic device 107, cellular telephone 103, game system 106, etc. Step 124 could be initiated by another action such as the user requesting a resource. An example of this is for the user 101 to send a search request to a search engine on resource server 115.

In step 126, the facet of the user's identity that is currently active is automatically determined based on the user's electronic device and other environment conditions. For example, if the user 101 attempts to access a document from over an employer's VPN, this access (along with possibly other factors) may imply that the user 101 is acting as an employee. As another example, if the user 101 attempts to access a document from a personal folder on the work computer 102b, this may imply the currently active facet of the user's identity is the personal facet.

In step 128, user identity information for the active facet of the user's identity determined in step 126 is accessed. For example, the controller 109 determines a subset of the user identity information that is appropriate for the active facet of the user's identity. That subset of the user identity information is placed in a newly created data package and provided to the relevant devices and/or services.

In step 130, the user's interaction with one or more resources, using one or more devices communicating on the Internet or other network, is adapted based on the active facet of the user's identity. For example, the user 101 may be granted/denied access to a resource based on permissions associated with the active facet of the user's identity. Another example is for a search engine to tailor search results to the active facet of the user's identity. Still another example is for an e-commerce server to tailor product recommendations to the active facet of the user's identity. As another example, the people who are allowed to call the user 101 may be dependent on the active facet of the user's identity. As still another example, the controller 109 can determine which credit card information to use to make an electronic purchase based on the active facet of the user's identity. In one embodiment, the user identity information is used to adapt the user interaction with resources to the active facet of the user's identity.

FIG. 2A is a block diagram of one embodiment of an architecture for establishing identity information for different facets of a user's identity. The technology for adapting a user's experience when accessing a variety of resources can be implemented with many different architectures, with the architecture of FIG. 2A being one suitable architecture that is provided for example purposes only in order to facilitate explanation of the ideas introduced above. The architecture of FIG. 2A includes a number of hosts 202(1)-202(n) at a first layer, and a facet handler 204 and user identity information storage 206 at a second layer. At a third layer is an authentication and authorization (AA) provider 214. A host 202 may refer to a host software application or a host device. The architecture may have one or more electronic devices (“host devices”) at the host layer. There may be multiple host software applications running on a single host device. As used herein, the term software application includes, but is not limited to, an application implemented in software and/or an operating system. The facet handler 204 may reside on a separate electronic device from the hosts 204 or may reside on the same electronic device as one or more of the hosts 202. The AA provider 214 may reside on the same electronic device as the facet handler 204 or a different electronic device. Typically, the AA provider 214 resides on a different computing device than the hosts 202, but that is not an absolute requirement.

The facet handler 204 manages the user identity information storage 206, which stores user identity information 207. The user identity information 207 may include baseline user identity information 207 such as a user name, email address, credit card information, etc. The baseline user identity information 207 is information that may be pertinent to more than one facet. The user identity information 207 may also include user identity information 207 that is specific to one facet of the user's identity.

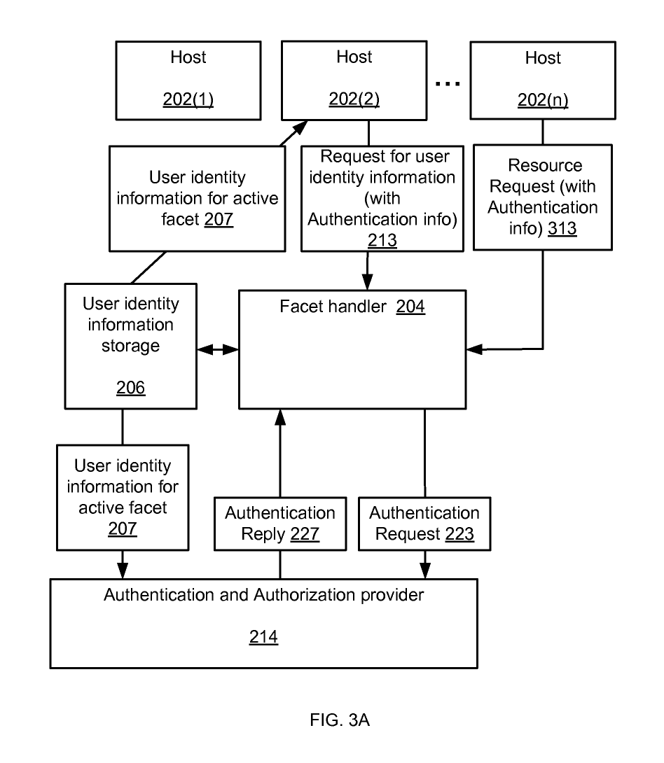

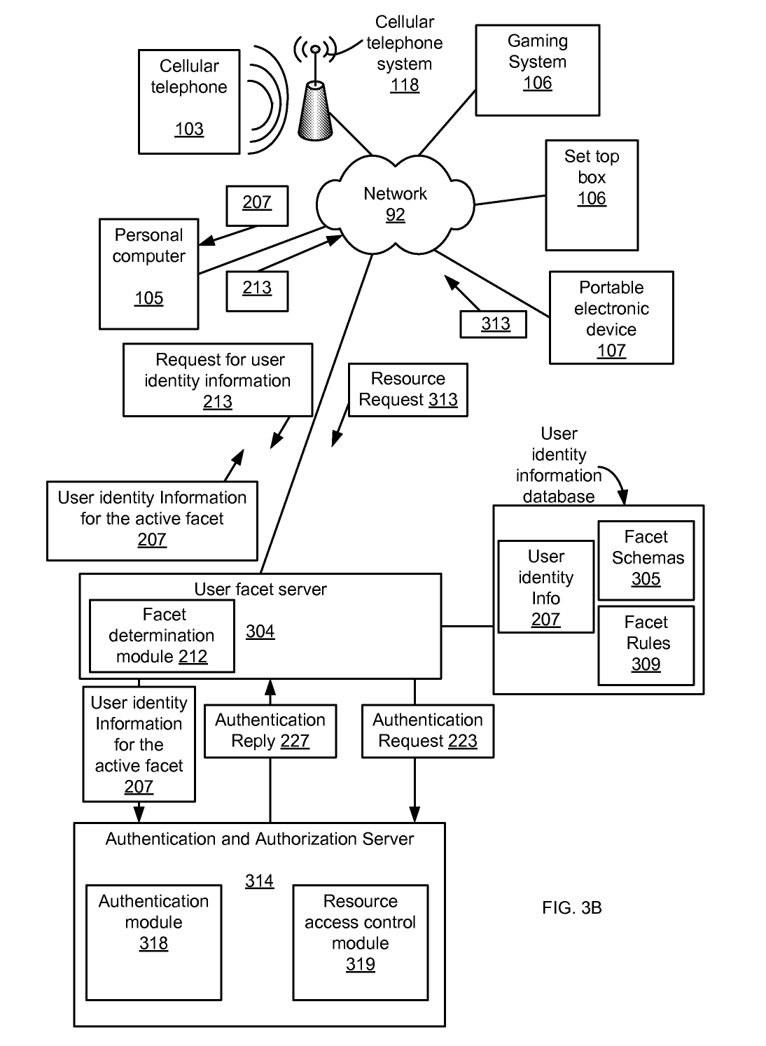

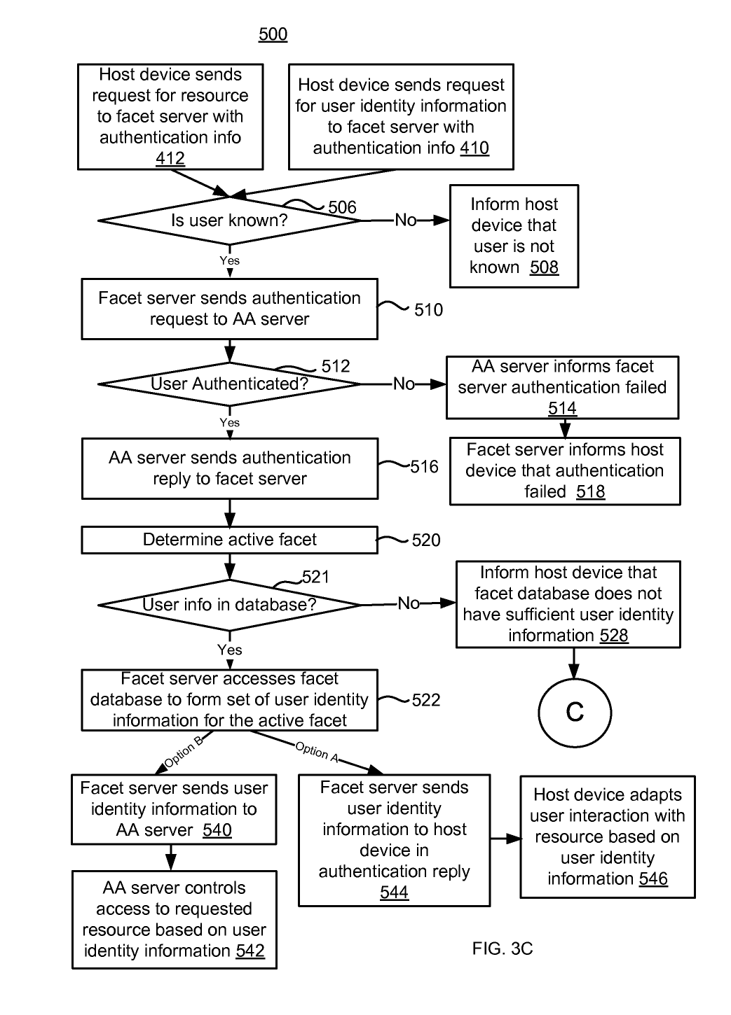

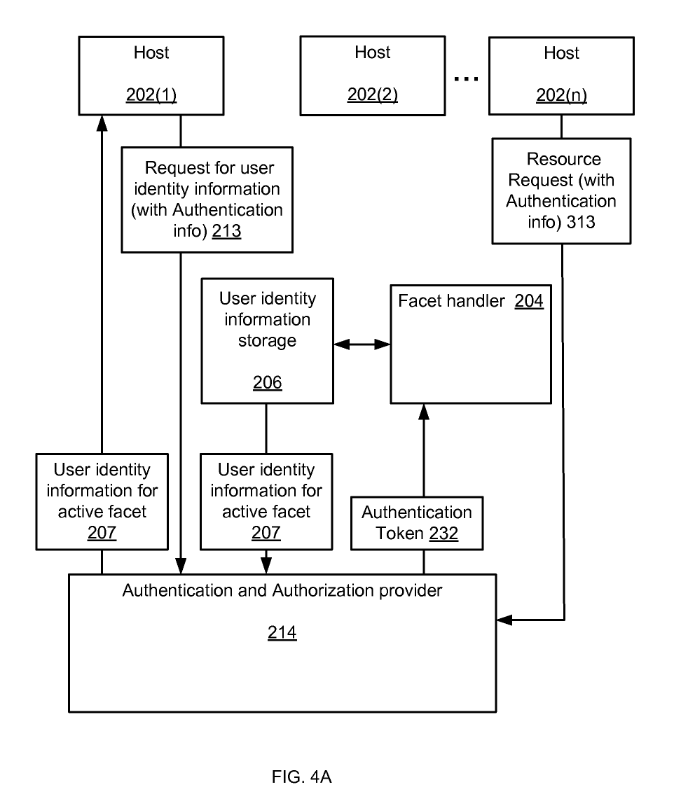

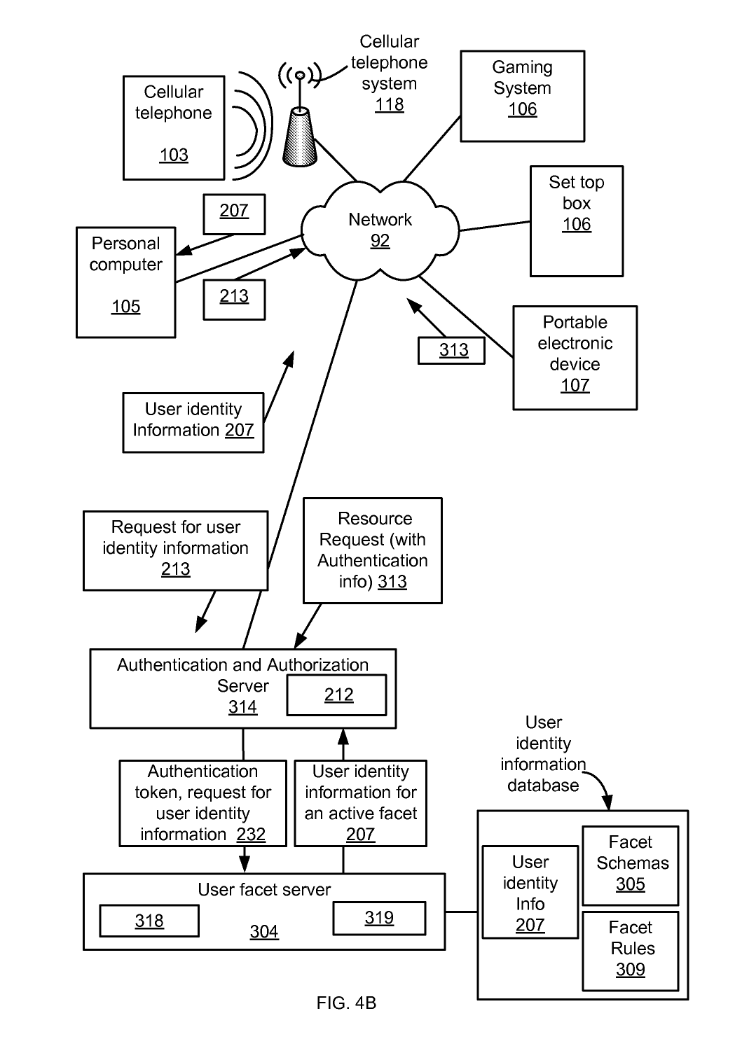

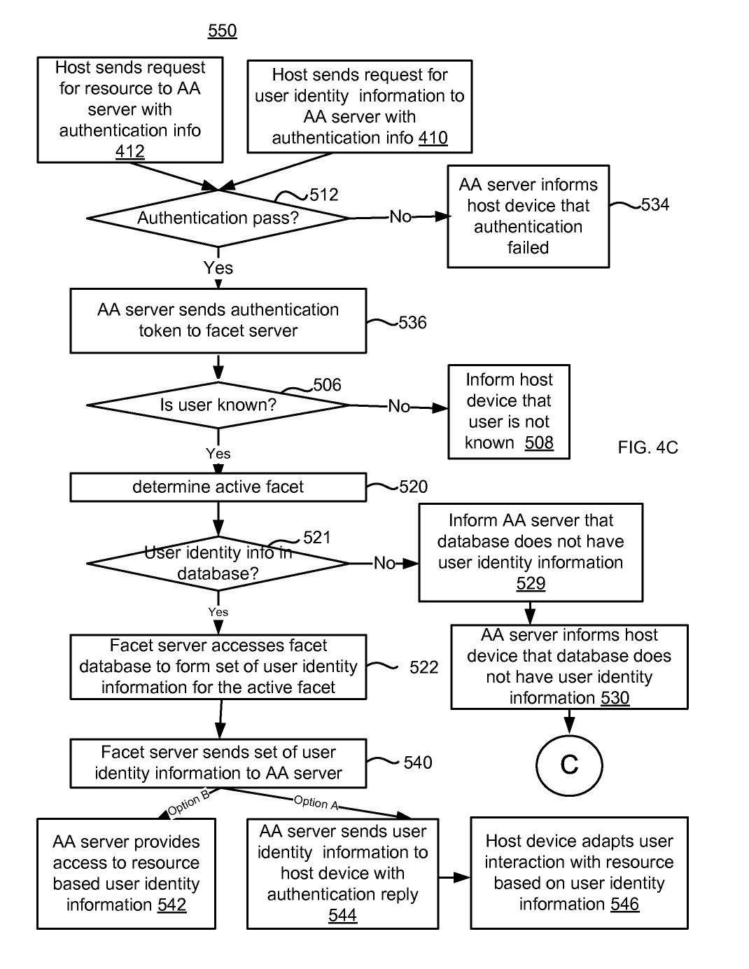

Specifically, the facet handler 204 receives user identity information 207(1)-207(n) from the hosts 202(1)-202(n) and stores the user identity information 207 in the user identity information storage 206. The facet handler 204 is also able to perform other functions such as determining a facet of the user's identity that is currently active and provide a subset of the user identity information 207 that corresponds to the active facet of the user's identity to a device at a different layer of the architecture. These other functions of the facet handler 204 are discussed in connection with FIGS. 3A and 4A.

The AA provider 214 authenticates that a user of one of the hosts 202 is who the user purports to be. Note that it is not an absolute requirement that the different layers be implemented by different devices. For example, a single electronic device might implement the facet handler 204 and one or more of the hosts 202, or any other combination of components. The system in FIG. 2B depicts an example implementation of the architecture in FIG. 2A. However, note that different devices than those shown in FIG. 2B may be used to implement the architecture in FIG. 2A.

FIG. 2B is a block diagram of one embodiment of a system for establishing user identity information 207 for different facets of a user's identity. The system includes a number of electronic devices that are accessed by a user such as a personal computer 102a, 102b, cellular telephone 103, game system 106, and portable electronic device 107. The various electronic devices will be referred to as “host devices” and may correspond to the hosts 202 in FIG. 2A. The system further includes a user facet server 304 and a user identity information database 306. The user facet server 304 may correspond to the facet handler 204 in FIG. 2A. The user identity information database 306 may correspond to the identity information storage 206 in FIG. 2A. The system further includes an authentication and authorization (AA) server 314, which may correspond to the AA provider 214 in FIG. 2A. Together, the facet server 304 and AA server 314 are one implementation of the controller 109 of FIG. 1A.

The host devices communicate with the facet server 304 via network 92, which may be implemented as a number networks. For example, the cellular telephone 103 accesses the network 92 via the cellular telephone system 118. The personal computer 102a might access the facet server 304 via the Internet. An example of the game system 106 is the XBOX® video game system, which is provided by Microsoft Corporation of Redmond, Wash. Another example of the game system 106 is the XBOX 360® video game and entertainment system, which is also provided by Microsoft Corporation of Redmond, Wash. The system could have many other types of electronic devices, including but not limited to, a television set.

The user facet server 304 has a facet determination module 212, which is software that is used to determine the currently active facet of the user's identity. The user identity information database 306 includes user identity information 207 for different users. Each set of user identity information 207 may include some unique identifier of the user, baseline user identity information 207, and facet specific user identity information. The unique identifier might be a user ID/password combination, but could be some other identifier. The baseline user identity information 207 includes information that may be relevant to more than one facet, such as a home address, email address, credit card information etc. The facet specific user identity information includes information that is typically specific to one facet, although in some cases might be pertinent to more than one facet. For example, the user's screen name for a game system is facet specific.

The user identity information database 306 also includes facet schemas 305, which define the data format for information included in each facet. Note that a single facet schema 305 can be used for different users 101. For example, there might be a “gamer schema” that is used for many different users 101. However, it is possible to modify a facet schema 305 for a given user 101. For example, a host device might send some additions to the gamer facet schema 305 for a particular user 101.

Database 306 also includes facet rules 309, which help the facet determination module 212 determine which facet of the user's identity is active. For example, facet rules 309 might state the user 101 is acting as an employee based on environment conditions such as day/time and user's location. For illustrative purposes, the following are example facet rules 309:

1) If time of day is between 9:00 AM-5:00 PM AND day is Monday-Friday AND device is work computer, THEN employee facet is active.

2) If time of day is NOT between 9:00 AM-5:00 PM OR day is between Saturday-Sunday AND device is cellular telephone, THEN employee facet is NOT active.

3) If time of day is between 9:00 AM-5:00 PM AND user's location is home, THEN either personal facet or parent facet is active.

The facet rules 309 may be provided by the host devices such that the user can supply the facet rules 309. However, note that is it not an absolute requirement that the facet rules 309 are supplied by the user 101.

The AA server 314 has an authentication module 318 to authenticate that the user 101 of one of the host devices 102, 103, 105, 106 is who the user purports to be. In one embodiment, the facet server 306 sends an authentication request 223 to the AA server 314, which returns an authentication reply 227. The AA server 314 may also have a resource access control module 319 to control access to resources requested by the user. Note that module 319 is not necessarily used when establishing user identity information 207 in the database 306.

FIG. 2C is a flowchart illustrating one embodiment of a process for creating or supplementing the user identity information 207 for the various facets of the user's identity. The process of FIG. 2C can be used by the components of FIG. 2B; therefore, FIG. 2B will be referred to when discussing the process. The process of FIG. 2C can also be used with other components and systems.

The process begins by the user 101 accessing one of the user's electronic devices, which determines that the facet server 304 should be contacted. In step 342, the facet server 304 is contacted by one of the host devices 102a, 102b, 103, 106, and 107. In one embodiment, software on a host device determines that the facet server 304 should be accessed to provide user identity information 207 to the facet server 304. For example, the software might track whether the user 101 has already provided any user identity information 207. If the user 101 has not yet provided any user identity information 207, then the software on the host device accesses the facet server 304 to provide such user identity information 207. In one embodiment, prior to contacting the facet server 304, the host device requests the user 101 to provide authentication information such as a user ID/password combination. The host device passes the authentication information to the facet server 304 when contacting the server 304.

In step 344, the facet server 304 sends an authentication request 223 to the AA server 314 in order to authenticate the user 101. The facet server 304 may forward the authentication information that was provided by the host device in step 342.

In step 346, the authentication module 318 in the AA server 314 determines whether the user 101 is who the user purports to be. If the user 101 is not who the user purports to be, then the AA server 314 informs the facet server 304 that authentication of the user 101 failed (step 350). In this case, the facet server 304 informs the host device that authentication failed and the process ends (step 352). If the user 101 is who they purport to be, the AA server 314 informs the facet server 304 that the user 101 has been authenticated (step 348). Then, the process continues at step 345.

In step 354, the facet server 304 determines whether this is the first access of the facet server 304 for this host device. If it is, then the process continues at step 356 in which the facet server 304 determines whether there is already any baseline identity information in the user identity information database 306 for this user 101. If baseline identity information already exists, then the facet server 304 sends the baseline identity information to the host device, in step 360, with a request that the host device ask the user 101 to verify the baseline identity information. If no baseline identity information exists in database 306, then the facet server 304 requests that the host device provide baseline identity information (step 358).

Returning now to the decision at step 354, if the facet server 304 determined that this was not the first access of the facet server 304 by the host device, then the facet server 304 asks the host device whether it has any user identity information 207 to add to the user identity information database 306 (step 362). This provides the host device an opportunity to add either baseline identity information or facet specific identity information.

In step 364, the host device optionally provides user identity information 207. This user identity information 207 could include additional baseline identity information such as addresses, phone numbers, etc. The facet specific information may include identity information that is typically specific to one facet. The host device might send additions to a facet schema 305 that are unique to this user and/or host device. The facet specific identity information may also include facet rules 309 that help the facet determination module 212 determine the active facet of the user's identity. As an example, the facet rules 309 could specify environment conditions for determining the active facet of the user's identity. Example factors to be used in the rules include, but are not limited to, time of day, day of week, holidays, user's present location, etc.

In one embodiment, the user identity information 207 in the user identity information database 306 is used by the host devices to adapt the user experience with resources accessed when using the host device to the active facet of the user's identity. However, it is not required that the user identity information 207 is utilized by the host devices. In one embodiment, an electronic device other than a host device or a service uses the user identity information 207 to adapt the user experience when operating one of the host devices to the active facet of the user's identity. For example, the facet server 304, the AA server 314, or some other server or entity may utilize the user identity information 207 to adapt the user's interactions with resources accessed by one of the host devices to the active facet of the user's identity. In one embodiment, the user identity information 207 is provided to a server that hosts a search engine to adapt the search results to the active facet of the user's identity. In one embodiment, the user identity information 207 is provided to an e-commerce server to enable providing facet specific product or service recommendations to the user 101.

FIG. 2D is a flowchart illustrating one embodiment of a process of the host device accessing user identity information 207. Therefore, the host device is able to utilize the user identity information 207 to adapt the user's interaction with resources to the active facet of the user's identity when using the host device. The process of FIG. 2D represents one example implementation of steps 124, 126, and 128 of FIG. 1B.

In step 402, a user requests an action at one of the host devices. The action could be the user 101 logging onto the host device, an attempt to access a file, an attempt to access a service, or any other action. Step 402 is one implementation of a user accessing one of the electronic devices (step 124, FIG. 1B).

In step 404, the host device determines whether it knows the facet that is appropriate for the current user action. For example, the host device might keep track of the active facet of the user's identity and know that the personal facet of the user's identity is active; however, the user 101 may be attempting to access a resource over a VPN. Therefore, the host device may decide that a check should be performed to verify the active facet of the user's identity. In one embodiment, any time that the user attempts a resource request, the host device takes steps to determine the active facet of the user's identity.

If the host does not know the active facet of the user's identity, then in step 406 the host device attempts to determine the active facet of the user's identity given the current environment conditions. Further details of a host device attempting to determine an active facet of the user's identity are discussed with respect to FIG. 8. Note that the host device is not required to attempt to determine the active facet of the user's identity. Instead, the host could request the facet server 304 (or some other device) to make this determination.

If the host device successfully determines the active facet of the user's identity in step 406 (see step 407) or if the active facet of the user's identity was known at step 404, the host device determines whether it already has user identity information 207 for the active facet of the user's identity (step 408). If the host device has the user identity information 207, then the process is complete. The host device may then utilize the user identity information 207 to adapt the user interaction with resources when using the host device to the active facet of the user's identity (step 130, FIG. 1B).

If the host device determines, in step 408, that it does not have the user identity information 207, then the host device sends a request to either the facet server 304 or the AA server 314 for user identity information 207 for the active facet of the user's identity in step 410a. Steps 408 and 410a are one implementation of accessing user identity information 207 for the active facet of the user's identity (step 128, FIG. 1B).

In some cases, the host device is either unable to determine the active facet of the user's identity or does not attempt to determine the active facet of the user's identity. Thus, if at step 407 the active facet of the user's identity is not yet determined, then the host device sends a request to either the facet server 304 or AA server 314 to determine the active facet of the user's identity, in step 410b. In one embodiment, this request also includes a request for the user identity information 207 for the active facet of the user's identity. However, the host device could first request that the active facet of the user's identity be determined and then determine whether it needs to request the user identity information 207.

As previously mentioned, an electronic device other than the host device can utilize the user identity information 207 in order for the user experience to be adapted to the current facet. In one embodiment, the host device sends a request to either the facet server 304 or the AA server 314, which take some action based on the user identity information 207 for the active facet of the user's identity. As an example, the user is granted or denied access to a resource based on the user identity information 207 for the active facet of the user's identity.

FIG. 2E is a flowchart of one embodiment of a process of the host device making a resource request and is one example of the user identity information 207 being utilized by an electronic device other than one of the host devices. Overall, various steps in the process are one implementation of steps 124, 126, and 128 of FIG. 1B.

In step 452, a user makes a resource request from one of the host devices. As an example, the user 101 attempts to access a server 111 over an employer's VPN. Step 452 is one implementation of a user accessing one of the electronic devices (step 124, FIG. 1B).

In step 404, the host device determines whether it knows the active facet of the user's identity that is appropriate for the resource request. If the facet is not known, then in step 406, the host device may attempt to determine the facet of the user's identity that is appropriate given the user action.

If the host device is able to determine the active facet of the user's identity in step 406 (or if the active facet of the user's identity is known in step 404), then the host device to send a resource request to either the facet server 304 or the AA server 314 to request access to the resource in step 412a. This request identifies the active facet of the user's identity.

However, if the active facet of the user's identity was not yet determined at step 407, then the host device sends a resource request to either the facet server 304 or the AA server 314 to request access to the resource in step 412b. This request does not identify the active facet of the user's identity. Because the request does not identify the active facet of the user's identity, then the facet server 304 will determine the active facet of the user's identity.

Note that the host device requesting a resource is one example of an electronic device other than the host device utilizing the user identity information 207 to adapt the user interaction with resources to the active facet of the user's identity. In this case, the adaption is to control what resources are available to the user based on the active facet of the user's identity. It will be understood that devices other than the host devices can utilize the user identity information 207 in other ways to adapt the user experience to the active facet of the user's identity.

FIG. 3A is a block diagram of one embodiment of an architecture of a system that customizes the user's experience based on the facet of the user's identity that is currently active. The architecture is similar to that of the architecture of FIG. 2A, which depicts user identity information 207 being established. FIG. 3A depicts the facet handler 204 providing a subset of the user identity information 207 for an active facet of the user's identity in response to a request from one of the host devices 202. Note that the user identity information 207 may be provided to one of the host devices (e.g., host 202(n)), to the AA provider 214, or to another device. The device that receives the user identity information 207 is then able to adapt the user's interaction with a resource based on the user identity information 207.

As previously mentioned, the facet handler 204 may be implemented with one or more devices that are able to determine the active facet of the user's identity. Moreover, facet handler 204 is able to provide a subset of the user identity information 207 that corresponds to the active facet of the user's identity to another device. In one embodiment, the facet handler 204 receives a request 213 for user identity information 207 from one of the hosts 202. For example, host 202(n) may send the request 213 to the facet handler 204. The request 213 for user identity information may include authentication credentials such as a username/password pair. The facet hander 204 may pass the authentication credentials on to the AA provider 214 in an authentication request 223. The AA provider 214 sends back an authentication reply 214, which indicates whether the user has been authenticated.

The facet handler 204 is able to determine the active facet of the user's identity for the user 101 and extract a subset of the user identity information 207 from the user identity information storage 206 based on the active facet of the user's identity. The user identity information 207 for the active facet of the user's identity may be sent to the host (e.g., to host 202(2)) such that that host 202 may adapt the user's interaction with resources based on the active facet of the user's identity.

In one embodiment, the facet handler 204 receives a resource request 313 from one of the hosts 202. For example, host 202(n) may send a resource request 313 to the facet handler 204. In this embodiment, the user identity information 207 for the active facet of the user's identity may be sent to the AA provider 214 such that AA provider 214 may control user access to a resource based on the user identity information 207 for an active facet of the user's identity. For example, AA provider 214 controls access to a resource that is requested by host 202(n).

Note that FIG. 3A depicts a general architecture that may be implemented by devices in many ways. For purposes of illustration, one example of devices that implement the architecture is depicted in FIG. 3B. Note that the architecture of FIG. 3A is not limited to the example implementation of FIG. 3B.

FIG. 3B is a block diagram of one embodiment of a system for responding to requests from host devices based on an active facet of the user's identity of a user's identity. The system includes a number of electronic devices that are accessed by a user such as a personal computer 102a, 102b, cellular telephone 103, game system 106, and portable electronic device 107. The electronic devices may correspond to the host layer of FIG. 3A. Note that an electronic device may have one or more host applications that interact with the system. The system further includes a user facet server 304 and a user identity information database 306, which may correspond to the facet handler 204 and user identity information storage 206 of FIG. 3A. The AA server 314 may correspond to the AA provider 214 of FIG. 3A.

The user facet server 304 has a facet determination module 212, which is used to determine the active facet of the user's identity. The facet determination module 212 may be implemented with software. The user identity information database 306 includes user identity information 207 for different users. The user identity information database 306 may also includes facet schemas 305 which define the data format for information for each facet. Database 306 also includes facet rules 309, which enable the facet determination module 212 to determine which facet of the user's identity is active. A process such as that described in FIG. 2C may be used to populate the user identity information 207 in the database 306.

The AA server 314 has an authentication module 318 that authenticates that a user of one of the host devices 102, 103, 105, 106 is who the user purports to be. The authentication module 318 may be implemented with software. The facet server 306 sends an authentication request 223 to the AA server 314, which returns an authentication reply 227. The AA server 314 has a resource access control module 319 to control access to resources requested by the user 101.

FIG. 3C is a flowchart illustrating one embodiment of a process 500 for responding to requests from host devices in a manner that is customized based on the active facet of the user's identity. In process 500, the host devices send requests to the facet server 304. The system of FIG. 3B will be referred to when discussing process 500; however, process 500 is not limited to the system of FIG. 3B. Process 500 begins under one of two situations: either the host device is requesting user identity information 207 for an active facet of the user's identity (step 410) or the host device is requesting access to a resource (step 412). The requests from the host device may or may not identify the active facet of the user's identity. If the active facet of the user's identity is not identified in the request, then the facet server 304 will determine the active facet of the user's identity.

Step 410 is an entry point when the host device is requesting user identity information 207. This request may include authentication information and may or may not identify an active facet of the user's identity. Step 410 of process 500 may correspond to steps 410a and 410b of FIG. 2D. Step 412 is an entry point when the host device is requesting access to a resource. This request may include authentication information and may or may not identify an active facet of the user's identity. Step 412 of process 500 may correspond to steps 410a and 410b of FIG. 2E.

In step 506, the facet server 304 determines whether the user 101 is known by the facet server 304. In one embodiment, the facet server 304 determines whether there is an entry in the user identity information database 306 for the user. If there is no entry (user is not known), then the facet server 304 informs the host device that the user is not known in step 508.

If the user is known by the facet server 304, then process 500 continues at step 510 in which the facet server 304 sends an authentication request 223 to the AA server 314. The authentication module 318 in the AA server 314 validates the user's authentication credentials in step 512. If the user 101 is not who the user purports to be, then the AA server 314 informs the facet server 304 that authentication failed (step 514). The facet server 304 then informs the host device that authentication failed in step 518. The process 500 then ends.

If the user is successfully authenticated by the AA server 314, the AA server 314 informs the facet server 304 of this in the authentication reply 227, in step 516.

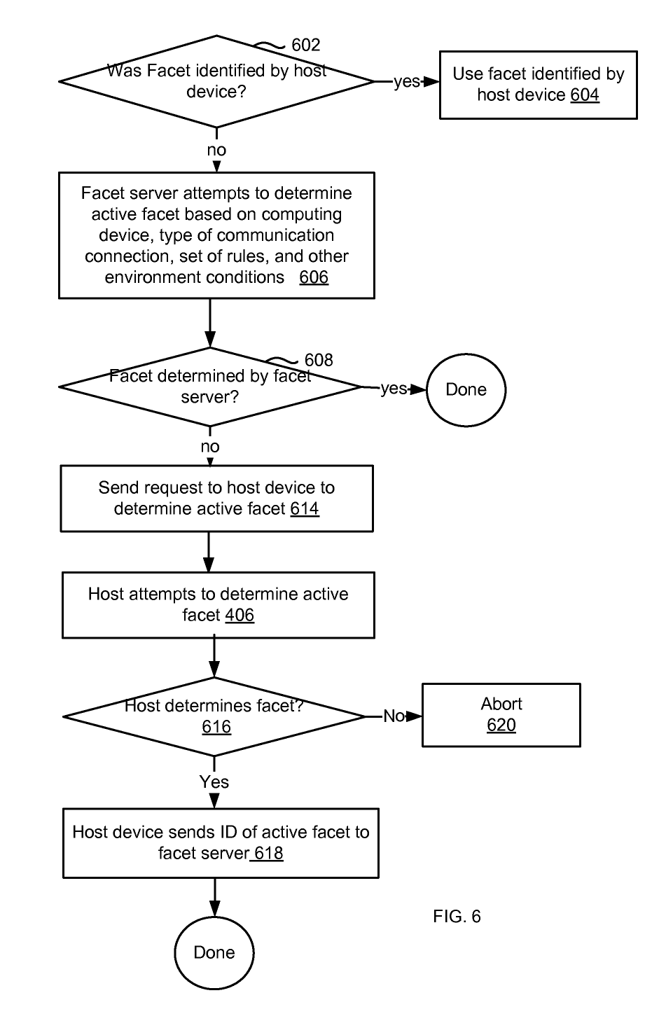

Next, the active facet of the user's identity is determined in step 520. Note that the host device might have already determined the active facet of the user's identity and sent an identifier of the active facet of the user's identity to the facet server 304. However, in many cases the facet server 304 determines the facet (or facets) of the user's identity that is active based on data such as the host computing device and environment conditions. FIG. 6 shows a flowchart of one embodiment of determining the active facet of the user's identity. However, other techniques may be used.

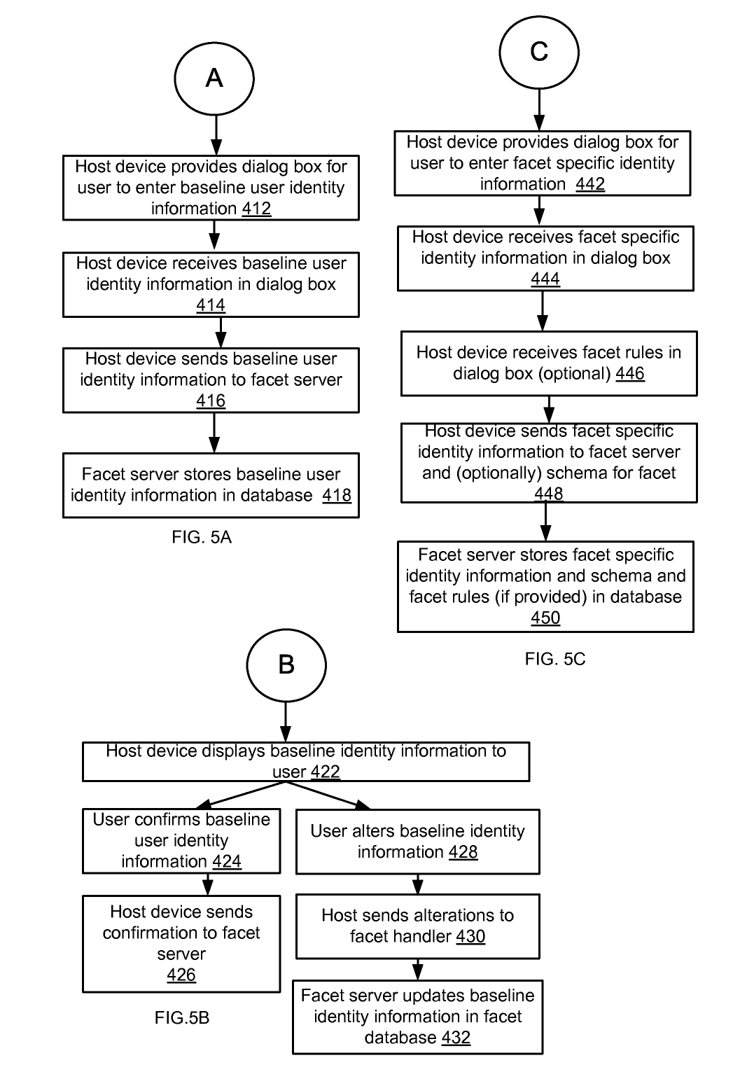

In step 521, the facet server 304 determines whether there is any user identity information 207 in the user identity information database 306 for the active facet of the user's identity, or at least for the user 101. The facet server 304 attempts to locate user identity information 207 that is specific to the active facet of the user's identity. However, if there is not any user identity information 207 that is specific for the active facet of the user's identity, baseline identity information for the user 101 may suffice. If the facet server 304 determines that there is not sufficient user identity information 207, then the facet server 304 informs the host device that the user identity information database 306 does not have sufficient user identity information 207, in step 528. If the host device is informed that there is not sufficient user identity information 207, the host device may then proceed to provide the facet server 304 with user identity information 207 by performing the process of FIG. 5C.

If the database 306 does have sufficient user identity information 207, then the facet server 306 forms a set of user identity information 207 for the active facet of the user's identity in step 522. In some cases, the set of user identity information 207 contains at least some information that is specific to the active facet of the user's identity in the user identity information database 306. However, the set of user identity information 207 may contain some baseline identity information also. In some cases, the set of user identity information 207 contains baseline information but no facet specific identity information.

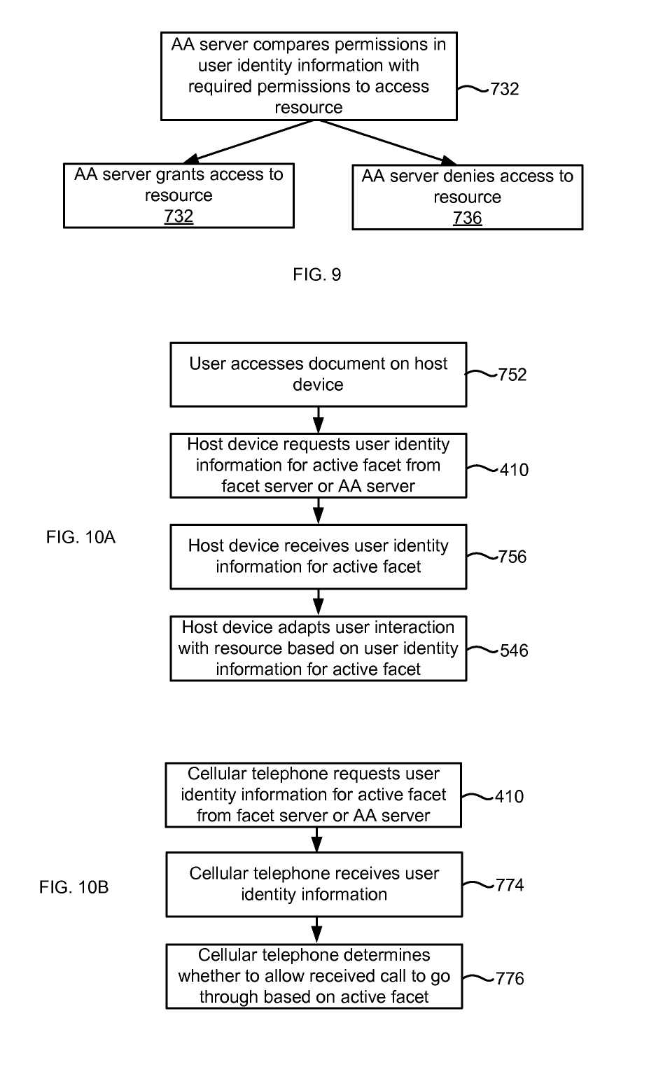

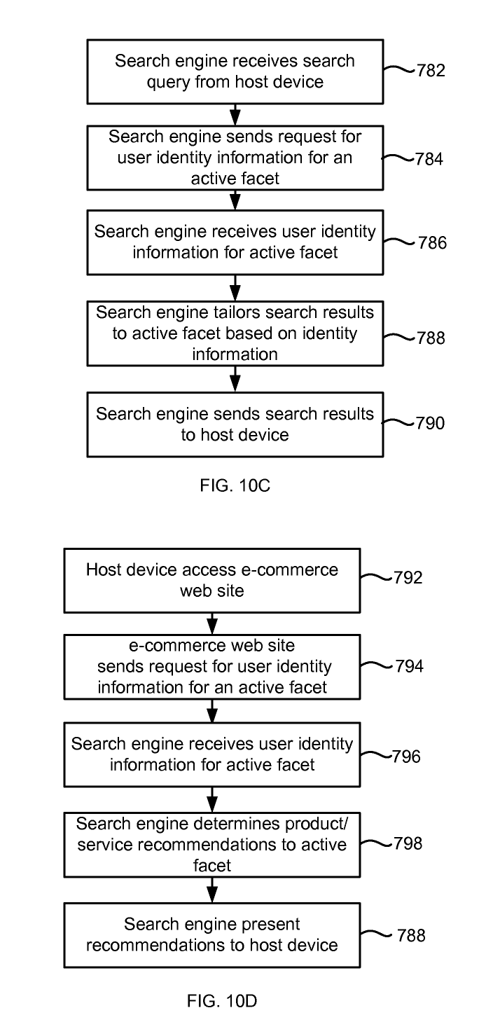

Next, the facet server 304 sends the set of user identity information 207 to either the host device or the AA server 314. In Option A, the facet server 304 sends the set of user identity information 207 to the host device in an authentication reply. The host device then adapts user interaction with the resource based on the set of user identity information 207. FIGS. 10A, 10B provide examples of the host device adapting user interaction with the resource based on the set of user identity information 207. In Option B, the facet server 304 sends the set of user identity information 207 to the AA server 314. The AA server 314 then controls access to the resource based on the set of user identity information 207. FIG. 9 provides an example of the AA server 314 controlling access to a resource based on the set of user identity information 207.

As an alternative to step 540 of the facet server 304 sending the user identity information 207 to the AA server 314, the facet server 304 might send the user identity information 207 to a search engine such that the user's search results can be adapted to the active facet of the user's identity. This might be done if the original request from the host device prior to step 506 was a search request. In one embodiment, the search engine sends the request for the user identity information 207 to the facet server 304 instead of the host device making the request.

As another alternative to step 540 of the facet server 304 sending the user identity information 207 to the AA server 314, the facet server 304 might send the user identity information 207 to an e-commerce server engine such that the user's experience on the e-commerce web site can be adapted to the active facet of the user's identity. In one embodiment, the e-commerce server sends the request for the user identity information 207 to the facet server 304 instead of the host device making the request.

FIG. 4A is a block diagram of one embodiment of an architecture for responding to requests from host devices based on which facet of a user's identity is currently active. The architecture is similar to that of the architecture of FIGS. 2A and 3A. However, FIG. 4A depicts requests being made to the AA provider 214, which in turn requests user identity information 207 for an active facet of the user's identity from the facet handler 204. The requests may be a resource request 313 or a request for user identity information for an active facet of the user's identity. Note that the user identity information 207 may be provided to one of the host devices (e.g., host 202(1)), to the AA provider 214, or to another device. The device that receives the user identity information 207 is then able to adapt the user's interaction with a resource based on the user identity information 207.

The response to the request may provide user identity information 207 which can be used to adapt user interaction with resources to facets of the user's identity. In one embodiment, the response to the request includes controlling access to a resource requested by the user 101. Thus, the architecture adapts user interaction with resources to different facets of the user's identity.

The architecture includes a number of hosts 202(1)-202(n) at a first layer, a facet handler 204 and user identity information storage 206 at a second layer, and an AA provider 214 at a third layer. A host 202 may refer to a host software application or a host electronic device. The host layer may include one or more electronic devices. There may be multiple host software applications running on a single host device.

The facet handler 204 may reside on a separate electronic device from the hosts 204 or may reside on the same electronic device as one or more of the hosts 202. The AA provider 214 may reside on the same electronic device as the facet handler 204 or a different electronic device. Typically, the AA provider 214 resides on a different computing device than the hosts 202, but that is not an absolute requirement.

In one embodiment, the AA provider 214 receives a request 213 for user identity information from one of the hosts 202. The request 213 for user identity information 207 may include authentication credentials such as a username/password pair. The AA provider 214 may pass an authentication token 232 to the facet handler 204 to obtain user identity information 207 for an active facet of the user's identity. The facet handler 204 may determine the active facet of the user's identity, but the facet could be determined at a different layer of the architecture. The facet handler 204 sends user identity information 207 for the active facet of the user's identity to the AA provider 214. The AA provider 214 may send the user identity information 207 for the active facet of the user's identity to the host 202.

In one embodiment, the facet handler 204 receives a resource request 313 from one of the hosts 202. In this embodiment, the facet handler 204 may send user identity information 207 for the active facet of the user's identity to the AA provider 214 such that that AA provider 214 may control user access to a resource based on the user identity information 207 for an active facet of the user's identity.

Note that FIG. 4A depicts a general architecture that may be implemented by devices in many ways. For purposes of illustration, one example of devices that implement the architecture is depicted in FIG. 4B. Note that the architecture of FIG. 4A is not limited to the example implementation of FIG. 4B.

FIG. 4B is a block diagram of one embodiment of a system for responding to requests from host devices based on an active facet of the user's identity of a user's identity. The system includes a number of electronic devices that are accessed by a user such as a personal computer 102a, 102b, cellular telephone 103, game system 106, and portable electronic device 107. The electronic devices may correspond to the host layer of FIG. 4A. Note that an electronic device may have one or more host applications that interact with the system. The system further includes a user facet server 304 and a user identity information database 306, which may correspond to the facet handler 204 and user identity information storage 206 of FIG. 4A. The AA server 314 may correspond to the AA provider 214 of FIG. 4A.

The user facet server 304 has a facet determination module 212, which is used to determine the active facet of the user's identity of the user. The user identity information database 306 includes user identity information 207 for different users. The user identity information database 306 may also includes facet schemas 305, which define the data format for information for each facet. Database 306 may also includes facet rules 306, which help the facet determination module 212 determine which facet is active. A process such as that described in FIG. 4C may be used to populate database 306.

The AA server 314 has an authentication module 318 that authenticates that a user of one of the host devices 102, 103, 105, 106 is who the user purports to be. The facet server 306 sends an authentication request 223 to the server 314, which returns an authentication reply 227. The AA server 314 has a resource access control module 319 to control access to resources requested by the user 101.

FIG. 4C is a flowchart illustrating one embodiment of a process 550 for responding to requests from host devices based on an active facet of the user's identity of a user's identity. In process 550 the host devices send requests to the AA server 314. The system of FIG. 4B will be referred to when discussing the process. The process beings under one of two situations. Either the host device is requesting user identity information 207 for an active facet of the user's identity (step 410) or the host device is requesting access to a resource (step 412). The requests from the host device may or may not identify an active facet of the user's identity. If the active facet of the user's identity is not identified in the request, then the facet server 304 will determine an active facet of the user's identity.

Process 550 has two entry points. Step 410 is an entry point when the host device is requesting user identity information 207. This request may include authentication information and may or may not identify an active facet of the user's identity. Step 410 of process 550 may correspond to steps 410a and 410b of FIG. 2D. Step 412 is an entry point when the host device is requesting access to a resource. This request may include authentication information and may or may not identify an active facet of the user's identity. Step 412 of process 550 may correspond to steps 410a and 410b of FIG. 2E.

The authentication module 318 in the AA server 314 validates the user's authentication credentials in step 512. If the user is not who the user purports to be, the AA server 314 then informs the host device that authentication failed in step 534. The process then ends.

If the user is successfully authenticated by the AA server 314, the AA server 314 sends an authentication token 536 to the facet server 304 and request user identity information 207 for an active facet of the user's identity for the user 101, in step 536.

In step 506, the facet server 304 determines whether the user is known by the facet server 304. In one embodiment, the facet server 304 determines whether there is an entry in the user identity information database 306 for the user. If there is no entry (user is not known), then the facet server 304 informs the host device that the user is not known in step 508.

Next, the active facet of the user's identity is determined in step 520. Note that the host device might have already determined the active facet of the user's identity and sent an identifier of the active facet of the user's identity to the facet server 304. However, in many cases the facet server 304 determines the facet (or facets) of the user's identity that is active based on data such as the host computing device and environment conditions. FIG. 6 shows a flowchart of one embodiment of determining the active facet of the user's identity. However, other techniques may be used.

In step 521, the facet server 304 determines whether there is any user identity information 207 in the user identity information database 306 for the active facet of the user's identity, or at least for the user. The facet server 304 attempts to locate user identity information 207 that is specific to the active facet of the user's identity. However, if there is not any user identity information 207 that is specific to the active facet of the user's identity, baseline information for the user may suffice. If the facet server 304 determines that there is not sufficient user identity information 207, then the facet server 304 informs the AA server 314 that the user identity information database does not have sufficient user identity information 207, in step 529. The AA server 314 then informs the host device that there is not sufficient user identity information 207, in step 530. The host device may then proceeds to provide the facet server 304 with user identity information 207.

If the database 306 does have sufficient user identity information 207, then the facet server 306 forms a set of user identity information 207 for the active facet of the user's identity in step 522. The set of user identity information 207 may contain at least some information that is specific to the active facet of the user's identity in the database. However, the user identity information 207 may contain some baseline information also. In some cases, the user identity information 207 contains baseline information but no facet specific information.

Next, the facet server 304 sends the user identity information 207 to the AA server 314 in step 540. Then, the AA server may send the user identity information 207 to the host device in step 544 (Option A). The host device then adapts user interaction with the resource based on the user identity information 207 in step 546. In Option B, the AA server 314 controls access to the resource based on the user identity information 207 in step 542.

As an alternative to options A and B after step 540, the AA server 304 might send the user identity information 207 to a search engine such that the user's search results can be adapted to the active facet of the user's identity. This might be done if the original request from the host device prior to step 506 was a search request. In one embodiment, the search engine sends the request for the user identity information 207 to the AA server 304 instead of the host device making the request.

As another alternative to options A and B after step 540, the AA server 304 might send the user identity information 207 to an e-commerce server engine such that the user's experience on the e-commerce web site can be adapted to the active facet of the user's identity. In one embodiment, the e-commerce server sends the request for the user identity information 207 to the facet server 304 instead of the host device making the request.

FIG. 5A is a flowchart illustrating one embodiment of a process for providing baseline user identity information 207. The process may be performed by the host device after step 358 of FIG. 2C in which the facet server 304 requests that the host device provides baseline user identity information 207. Note that the process may also be performed without any request from the facet server 304.

In step 412, the host device provides a dialog box for the user to enter baseline information. Examples of baseline user identity information 207 include, but are not limited to, contact information such as addresses, telephone numbers, etc.

In step 414, the host device receives the baseline user identity information 207 from the user 101 in the dialog box. In step 416, the host device sends the baseline user identity information 207 to the facet server 304. In step 418, the facet server 304 stores the baseline user identity information 207 in the user identity information database 306.

FIG. 5B is a flowchart illustrating one embodiment of a process for a host device confirming baseline user identity information 207. The process may be performed by the host device after step 360 of FIG. 2C in which the facet server 304 requests that the host device confirm baseline user identity information 207 that is already in the user identity information database 306. Thus, prior to performing the process, the host device may have just received baseline information from the facet server 304 to confirm. For example, the baseline information that is already in the database 306 might have been sent to the facet server 304 by the user's home computer 102a. Now, the game system 106 is being requested to confirm that baseline information. This may occur the very first time that the game system 106 logs in to the facet server 304.

In step 422, the host device provides a dialog box for the user to confirm the baseline information received from the facet server 304. The user may either confirm the baseline information (step 424) or alter the baseline information (step 428). The host device either sends a confirmation that no changes are to be made to the baseline information (step 426) or may send the altered baseline information to the facet server 304 (step 430). In the event that the host device sends altered baseline information, the facet server 304 updates the baseline information in the user identity information database 306.

FIG. 5C is a flowchart illustrating one embodiment of a process for a host device providing user identity information 207. The process may be performed by the host device after step 528 of FIG. 3C or step 530 of FIG. 4C in which the host device is informed that the user identity information database 306 does not have facet specific information for the facet. Note that the process may also be performed without any request from the facet server 304.

In step 442, the host device provides a dialog box for the user 101 to enter identity information. In step 444, the host device receives the user identity information 207 from the user 101 in the dialog box. Typically, the identity information is associated with a particular facet. The dialog box may allow the user 101 to specify or confirm the active facet of the user's identity; however, that is not a requirement. Note that if the host device is providing the identity information after step 528 of FIG. 4C, then the facet will have been determined already. However, the user 101 may wish to override this facet.

In optional step 446, the host device receives facet rules 309 from the user 101 in the dialog box. For example, the user 101 specifies that certain windows of time correspond to the employee facet, others do not, and some are open ended.

In step 448, the host device sends the user identity information 207 to the facet server 304. The host device may also send a facet schema 305 for an active facet of the user's identity. However, the facet schema 305 may be provided to the user identity information database 306 in another manner. For example, there might be a web site that can be accessed to obtain facet schemas 305. In one embodiment, the host device sends additions to the facet schema 305. For example, the might be a generic gamer facet schema 305 to which host devices are allowed to add to or alter in same manner.

In step 450, the facet server 304 stores the user identity information 207 in the user identity information database 306. Note that there may already be an entry for the user 101 in the user identity information database 306, although perhaps no user identity information 207 for this facet of the user's identity.

FIG. 6 is a flowchart illustrating one embodiment of a process for determining facet of the user's identity is currently active. The process is one implementation of step 520 of FIG. 3C and FIG. 4C. In step 602, the facet server 304 checks whether the host device indicated the facet of the user's identity that is currently active. If so, then the facet of the user's identity indicated by the host device will be used as the active facet of the user's identity (step 604).

Often, the host device will not identify the active facet of the user's identity, in which case the facet server 304 attempts to determine the active facet of the user's identity in step 606. The facet server 304 attempts to determine the currently active facet of the user's identity based on one or more environment conditions, including (but not limited to) the type of host device, the type of communication connection, time of day, day of the week, geographic location, task being performed, season, as well as and one or more other environment conditions.

One example of resolving the active facet of the user's identity based, at least in part, on the host device is to note the type of host device being used (e.g., the host device being used is game system 106, such as an XBOX). This may lead to a strong presumption that the game facet is active. However, other conditions may override this presumption. For example, the user might have set up a condition that states that if the present time is between 10 AM and 5 PM on a weekday, then the user is not acting an a gamer.

The type of connection that the host device is using to access a resource is another factor that may be used to determine the active facet of the user's identity. For example, if the user is using their home computer 102a to access a resource over their employer's VPN, this may create a strong presumption that the employee facet is active.

The active facet of the user's identity can also be deduced by the user's location. Some computing devices (e.g. smart phones) can determine where they are based on GPS or based on communication with cell towers. If the user 101 is at the user's office, then the system may assume the user is acting as an employee. However, if the user 101 is at a soccer field, the system may assume that the user is acting as a soccer coach.

The facet server 304 may also use facet rules 309 that were provided by the user to attempt to determine the active facet of the user's identity. For example, the user 101 can specify time windows (including days of the week and seasons) during which it is presumed that the active facet of the user's identity is (or is not) a facet specified by the facet rules 309.

If the facet server 304 is able to determine the active facet of the user's identity based on the host computing device and one or more environment conditions, then the process concludes. However, in some cases the facet server 304 may not be able to unambiguously determine the active facet of the user's identity. In such cases, the facet server 304 sends a request to the host device to determine the facet (step 614). This request may include sending the host device a list of one or more facets that are candidates. The host device will attempt to determine the facet of the user's identity that is currently active using any of the criteria and methods discussed herein.

If the host device is able to determine the active facet of the user's identity, then the host device identifies the active facet of the user's identity to the facet server in step 618. However, if the host device is unable to determine the active facet of the user's identity, then the process aborts in step 620.

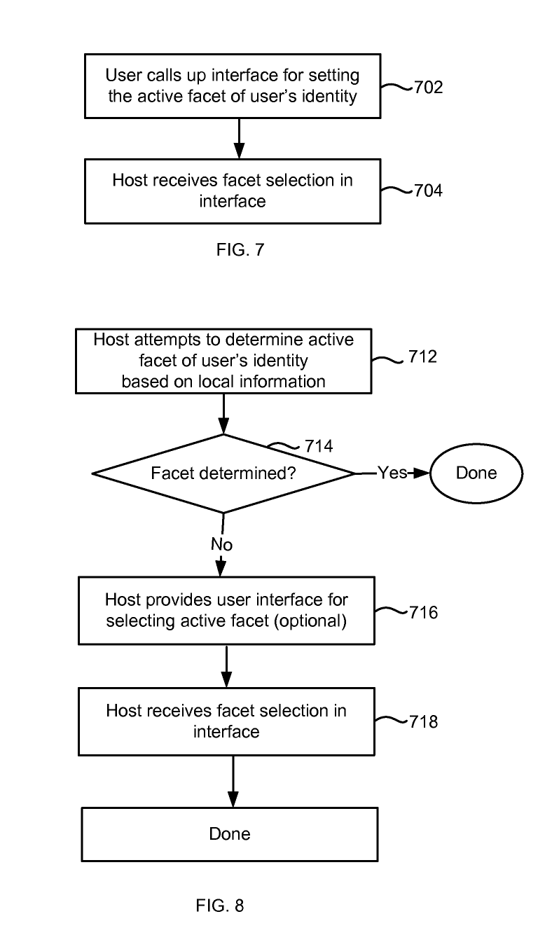

FIG. 7 is a flowchart illustrating one embodiment of a process for a user indicating which facet of their identity is active. In step 702, the user requests that the host device present an interface for setting the active facet of the user's identity. The interface may contain a list of possible facets to select from. The list may include the facets that the user 101 has previously used; however, facets not previously used may be presented in the interface. In one embodiment, the host device contacts the facet server 304 to obtain a list of facets to present to the user 101.

In step 704, the host device receives a selection in the interface. In one embodiment, the host device sets a flag or flags that specify the active facet of the user's identity. Note that in some embodiments, the user 101 may have more than one facet of their identity active at a time. As one example of having multiple facets of their identity active, the facets may be organized in a hierarchy. For example, at one level there is an employee facet and a non-employee facet. Below the employee facet is a lawyer sub-facet and a business generation sub-facet. Below the non-employee facet there is a family sub-facet, golf sub-facet, and movie buff sub-facet. The user 101 might choose between either the employee facet or the non-employee facet, which results in the sub-facets being active. Thus, while acting as an employee, the individual might be in either of two different sub-facets. As another example, a person might choose to be in both a family sub-facet and movie buff sub-facet, but not a golf sub-facet. Note that a sub-facet may be treated (and referred to) as a facet.

FIG. 8 is a flowchart illustrating one embodiment of a process for a host device determining which facet of the user's identity is active. The process is one implementation of step 406 of FIGS. 2D, 2E, and 6. Recall that step 404 occurs in FIGS. 2D and 2E if the host device determines that it does not know the active facet of the user's identity or the active facet of the user's identity is ambiguous. Recall that step 404 occurs in FIG. 6 if the facet server 304 is unable to determine the active facet of the user's identity.

In step 712, the host device attempts to determine the active facet of the user's identity based on local information. For example, the host device might have access to information that is not available to the facet server 304. One technique for the host device to identify a facet is based on information such as current time, location, and/or task being performed. However, other information such as the recent individual's browsing or task history might be tracked or accessed. The information may be collected from a variety of sources. If the individual has a calendar program, then this may be useful for identifying what facet the user 101 is expected to have at the present time. For example, if the calendar states that the user 101 has a doctor's appointment at the present time, this may be used to infer that the user is performing personal tasks and, therefore, the user's private or personal facet of their identity is active. The active facet of the user's identity may be also inferred from information in a calendar program's meeting notice such as the subject line, or meeting attendees. As a specific example, if the meeting attendees are co-workers, this may infer that the active facet of the user's identity is the employee facet. Other information such as the current location of the individual might be used to confirm or override the meeting information. If the individual is supposed to be in a particular room for the meeting, but is not, then this may indicate that the active facet is not the employee facet. For example, if the individual is actually off site at a doctor's appointment, then the active facet of the user's identity is probably not the employee facet.

If the host device determines that the active facet of the user's identity has been satisfactorily determined (step 714), then the process concludes. However, the host device may determine that the user 101 should be consulted for either verifying or selecting the active facet of the user's identity. If so, then the host device provides a user interface in step 716.

In step 718, the host device receives either the confirmation of the active facet of the user's identity or the outright selection of the active facet of the user's identity. The process then concludes.

FIG. 9 is a flowchart illustrating one embodiment of a process for an AA server 314 controlling access to a resource based on an active facet of the user's identity. The process is one implementation of step 542 of FIG. 3C or 4C. Recall that the AA server 314 received user identity information 207 prior to step 542. The user identity information 207 may include permissions or other information that allows the AA server 314 to control access to resources.

In step 732, the AA server 314 compares permission information in the user identity information 207 with required permissions to determine whether the user 101 should be permitted access to the resource. If the permissions for the active facet of the user's identity allow it, the user is granted access to the resource in step 734. For example, if the user is in the employee facet when attempting to access the corporate VPN, then the access is allowed. However, if the permissions for the active facet of the user's identity do not allow access, then access to the resource is denied in step 736. Note that if the user 101 leaves the company the permissions associated with the employee facet can be changed such that the user 101 no longer can access resources using the corporate VPN. However, any permissions for other facets of the user's identity can remain the same.

FIG. 10A is a flowchart illustrating an embodiment of a process of a host device adapting user interaction with a resource based on an active facet of the user's identity. The process is one implementation of step 546 of either FIG. 3C or 4C. In this example, a host device is adapting a user's interaction with a document being accessed on their work computer 102b. As an example, the host device may tailor the user interaction with the document to preferences that user has when the active facet of the user's identity is the personal facet. This may change a wide variety of behaviors such as settings in a word processing program to how the document is backed up. Note that if the user were acting as an employee, the behaviors might be different. For example, a different dictionary might be used in a spell-checking program when the user is acting as an employee.

In step 752, a user accesses a document on the host device (e.g., work computer 102b). In step 410, the host device requests user identity information 207 for the active facet of the user's identity from either the facet server 304 or the AA server 314. In step 756, the host device receives the user identity information 207 for the active facet of the user's identity.

In step 546, the host device adapts user interaction with the resource based on the user identity information 207 for the active facet of the user's identity. For example, the host device changes settings in a word processor to the user's personal settings instead of work settings.

FIG. 10B is a flowchart illustrating an embodiment of a process of a host device adapting user interaction with a resource based on an active facet of the user's identity. The process is one implementation of step 546 of either FIG. 3C or 4C. In this example, the host device is a cellular telephone that controls who is allowed to reach the user 101 based on the active facet of the user's identity.

In step 410, the cellular telephone requests user identity information 207 for an active facet of the user's identity from either the facet server 304 or the AA server 314. This is one implementation of step 410 of either FIG. 3C or 4C. In step 774, the cellular telephone receives the user identity information 207.

In step 776, the cellular telephone determines how it should process received telephone calls based on the user identity information 207. For example, if the user identity information 207 specifies that the user 101 does not desire to receive calls from the user's boss when not acting as an employee, then the cellular telephone can send such calls to voice mail when the user 101 is not in acting as an employee. On the other hand, the user might specify that calls from his daughter should always go through regardless of what facet of the user's identity is active.

FIG. 10C is a flowchart of one embodiment of a search engine adapting search results to an active facet of the user's identity. The process is one example of adapting a user's interaction with a resource that is accessed with one of the electronic devices to an active facet of the user's identity (step 130 of FIG. 1B). In step 782, the search engine receives a search query from a host device. In step 784, the search sends a request for user identity information 207 to the facet server 304 or the AA server 314. In step 786, the search engine receives a set of user identity information 207 for the active facet of the user's identity in response to the request of step 784. In step 788, the search engine tailors search results for the search query to the active facet of the user's identity, based on the user identity information 207. In step 790, the search engine sends the search results to the host device. Note that the search engine might obtain the user identity information 207 in a different manner. For example, the host device might provide the user identity information 207 to the search engine.

FIG. 10D is a flowchart of one embodiment of an e-commerce web site adapting a user's experience on the web site to an active facet of the user's identity. The process is one example of adapting a user's interaction with a resource that is accessed with one of the electronic devices to an active facet of the user's identity (step 130 of FIG. 1B). In step 792, the host device accesses the e-commerce web-site. In step 794, the e-commerce web-site sends a request for user identity information 207 to the facet server 304 or the AA server 314. In step 796, the e-commerce web-site receives a set of user identity information 207 for the active facet of the user's identity in response to the request of step 786. In step 798, the e-commerce web-site determines product/service recommendations for the user based on the user identity information 207, as well as other criteria normally used by a recommendations engine. In step 799, the e-commerce web-site sends the product/service recommendations to the host device. Note that the e-commerce web-site might obtain the user identity information 207 in a different manner. For example, the host device might provide the user identity information 207 to the e-commerce web-site.

In various embodiments, the host devices (e.g., personal computers 102a, 102b, cellular telephone 103, game system 106, portable electronic device 107), the facet server 304, AA server 314, controller 109, server 111, server 115 execute computer readable instructions that are stored on computer readable storage devices. For example, process depicted in FIGS. 1B, 2C, 2D, 2E, 3C, 4C, 5A, 5B, 5C, 6, 7, 8, 9, 10A, 10B, 10C, 10D may be implemented by executing, on a processor, instructions that are stored on a computer readable storage device. Computer readable storage device can be any available storage device that can be accessed by the electronic devices. Computer readable storage device includes volatile and nonvolatile, removable and non-removable media implemented in any method or technology for storage of information such as computer readable instructions, data structures, program modules or other data. Computer readable storage devices include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other storage device which can be used to store the computer readable instructions and which can accessed by the electronic devices.

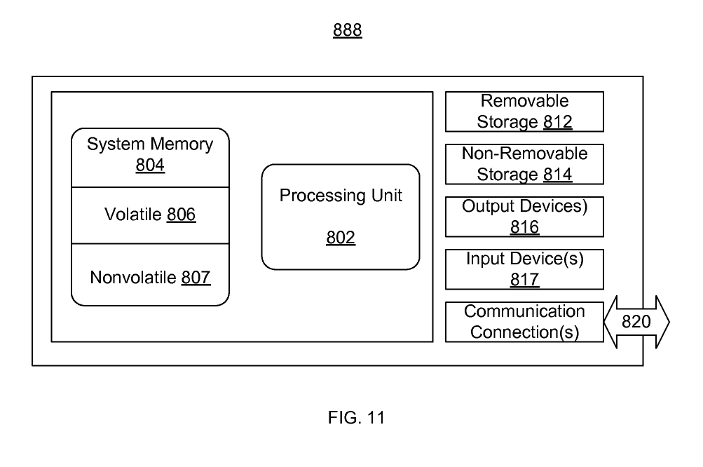

FIG. 11 depicts an example computer system 888 that may serve as a platform for embodiments. For example, computer system 888 is an example electronic device such as personal computers 102a, 102b, cellular telephone 103, game system 106, portable electronic device 107), the facet server 304, AA server 314, server 111, server 115 or other device that can be used to implement one or more of the processes described above. In its most basic configuration, the computer 888 typically includes a processing unit 802 and memory 804. Pending on the exact configuration and type of computing device, memory 804 may be volatile (such as RAM), non-volatile (such as ROM, flash memory, etc.) or some combination of the two. Additionally, computer 800 may also have mass storage (removable 812 and/or non-removable 814) such as magnetic or optical disks or tape.

Similarly, computer 888 may also have input devices 817 and/or output devices 816. Other aspects of device 888 may include communication connections 820 to other devices, computers, networks, servers, etc. using either wired or wireless media. For example, the client devices may have a wireless network connection that allows them to access the Internet or another network. The client devices may also have communication connections between themselves.

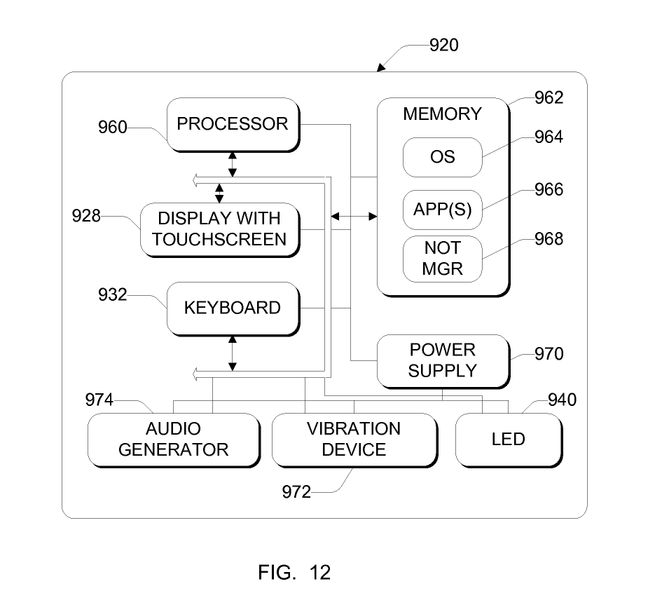

FIG. 12 shows functional components of a handheld computing device 920 that may serve as a platform for some embodiments. It has a processor 960, a memory 962, a display 928, and a keyboard 111 932. The memory 962 generally includes both volatile memory (e.g., RAM) and non-volatile memory (e.g., ROM, PCMCIA cards, etc.). An operating system 964 is resident in the memory 962 and executes on the processor 960. The H/PC 20 includes an operating system, such as the Windows® CE operating system from Microsoft Corporation or other operating system.

One or more application programs 966 are loaded into memory 962 and executed on the processor 960 by the operating system 964. Examples of applications include email programs, scheduling programs, PIM (personal information management) programs, word processing programs, spreadsheet programs, Internet browser programs, and so forth. The H/PC 920 also has a notification manager 968 loaded in memory 962, which executes on the processor 960. The notification manager 968 handles notification requests from the applications 966. At least one of the programs allows the device to access the employer's server 111, resource server 115, facet server 304 and/or the AA server 314. Some of the applications may be adapted to implement embodiments disclosed herein.

The H/PC 20 has a power supply 970, which is implemented as one or more batteries. The power supply 970 might further include an external power source that overrides or recharges the built-in batteries, such as an AC adapter or a powered docking cradle.

The H/PC 920 is also shown with three types of external notification mechanisms: an LED 940, a vibration device 972, and an audio generator 974. These devices are directly coupled to the power supply 970 so that when activated, they remain on for a duration dictated by the notification mechanism even though the H/PC processor and other components might shut down to conserve battery power. The LED 940 preferably remains on indefinitely until the user takes action. The current versions of the vibration device 972 and audio generator 974 use too much power for today's H/PC batteries, and so they are configured to turn off when the rest of the system does or at some finite duration after activation.

To make the drawing of FIG. 12 general to a variety of devices, not all components are depicted. The handheld computing device 920 could be used to implement a cellular telephone 103 with additional communication components. The apparatus of FIG. 12 can be used to implement the processes described above.

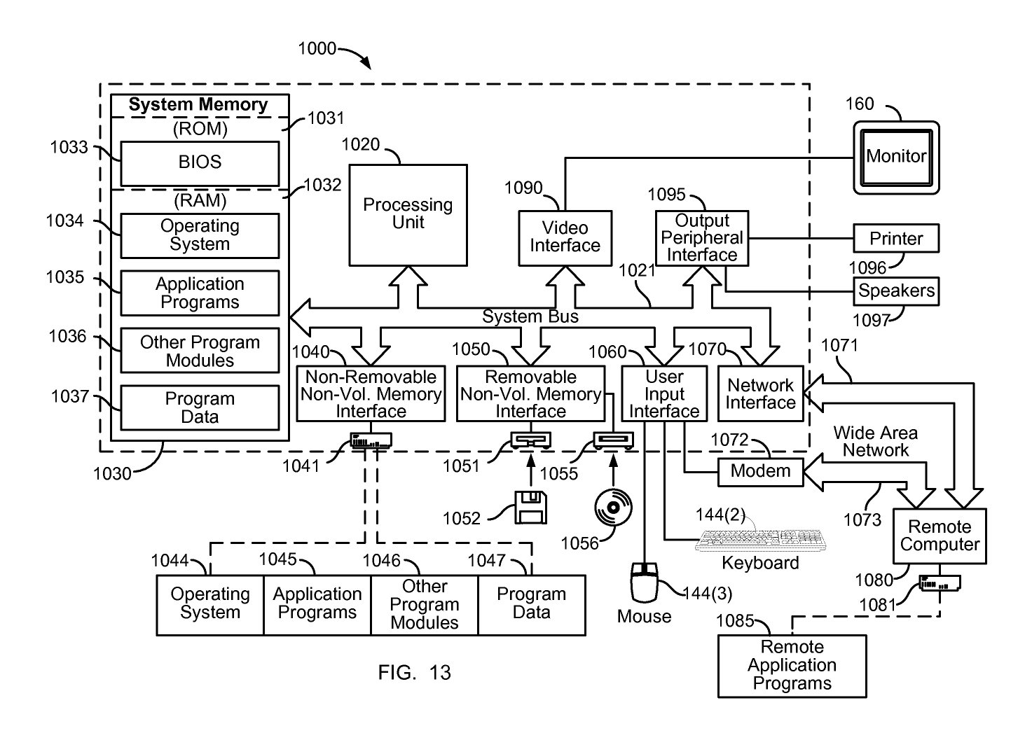

With reference to FIG. 13 an exemplary system for implementing some embodiments includes a general purpose computing device in the form of a computer 1000. For example, computer system 1000 may be used to implement client devices such as personal computer (102a, 102b). Components of computer 1000 may include, but are not limited to, a processing unit 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 1030 includes computer storage devices in the form of volatile and/or nonvolatile memory such as ROM 1031 and RAM 1032. A basic input/output system (BIOS) 1033, containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 12 illustrates operating system 1034, application programs 1035, other program modules 1036, and program data 1037. Applications programs 1035 may include a program that is able to access the facet server 304 or AA server 314 such as a web browser. Applications programs 1035 may also include a program for adapting user interactions with resources based on user identity information 207.

The computer 1000 may also include other removable/non-removable, volatile/nonvolatile computer storage devices. By way of example only, FIG. 13 illustrates a hard disc drive 1041 that reads from or writes to non-removable, nonvolatile magnetic media and a magnetic disc drive 1051 that reads from or writes to a removable, nonvolatile magnetic disc 1052. Computer 1010 may further include an optical media reading device 1055 to read and/or write to an optical media.

Other removable/non-removable, volatile/nonvolatile computer storage devices that can be used in the exemplary operating environment include, but are not limited to, magnetic tape cassettes, flash memory cards, DVDs, digital video tapes, solid state RAM, solid state ROM, and the like. The hard disc drive 1041 is typically connected to the system bus 1021 through a non-removable memory interface such as interface 1040. Magnetic disc drive 1051 and optical media reading device 1055 are typically connected to the system bus 1021 by a removable memory interface, such as interface 1050.

The drives and their associated computer storage devices discussed above and illustrated in FIG. 13, provide storage of computer readable instructions, data structures, program modules and other data for the computer 1000. In FIG. 13, for example, hard disc drive 1041 is illustrated as storing operating system 1044, application programs 1045, other program modules 1046, and program data 1047. These components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies.

A user may enter commands and information into the computer 1010 through input devices such as a keyboard 144(2) and a pointing device 144(3), commonly referred to as a mouse, trackball or touch pad. Other input devices (not shown) may include a microphone, joystick, game pad, satellite dish, scanner, or the like. These and other input devices are often connected to the processing unit 1020 through a user input interface 1060 that is coupled to the system bus 1021, but may be connected by other interface and bus structures, such as a parallel port, game port or a universal serial bus (USB). A monitor 160 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1000 may operate in a networked environment using logical connections to one or more remote computers, such as a remote computer 1080. The remote computer 1080 may be another electronic device in the shared workspace. However, the remote computer 1080 could be a device that is not in the shared workspace such as a personal computer, a server, a router, a network PC, a peer device or other common network node, and may includes many or all of the elements described above relative to the computer 1000, although only a memory storage device 1081 has been illustrated in FIG. 13. The logical connections depicted in FIG. 13 include a local area network (LAN) 1071 and a wide area network (WAN) 1073, but may also include other networks. Such networking environments are commonplace in offices, enterprise-wide computer networks, intranets and the Internet.

When used in a LAN networking environment, the computer 1000 is connected to the LAN 1071 through a network interface or adapter 1070. When used in a WAN networking environment, the computer 1010 typically includes a modem 1072 or other means for establishing communication over the WAN 1073, such as the Internet. The modem 1072, which may be internal or external, may be connected to the system bus 1021 via the user input interface 1060, or other appropriate mechanism. In a networked environment, program modules depicted relative to the computer 1000, or portions thereof, may be stored in the remote memory storage device. By way of example, and not limitation, FIG. 13 illustrates remote application programs 1085 as residing on memory device 1081. In some embodiments, remote application programs 1085 include a program that is downloaded to computer 1000. It will be appreciated that the network connections shown are exemplary and other means of establishing a communication link between the computers may be used. The apparatus of FIG. 13 can be used to implement the processes described above.

While some embodiments are implemented by a processor executing computer readable instructions that are stored on computer readable devices, this is not a requirement in all embodiments. Some embodiments may be implemented in hardware or a combination of hardware and software. For example, at least some of the steps of processes of FIGS. 1B, 2C, 2D, 2E, 3C, 4C, 5A, 5B, 5C, 6, 7, 8, 9, 10A, 10B, 10C, and/or 10D may be implemented within an ASIC. As a particular example, a portion of the electronic devices may be implemented with an ASIC.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A machine implemented method comprising:
electronically receiving, at a first electronic device from a second electronic device, a request associated with a resource with which a user wishes to interact;
determining a facet of the user's identity that is currently active based on one or more environment conditions; and
providing for the adaptation of user interaction with the resource based on the facet that is currently active.

2. The machine implemented method of claim 1 wherein the providing for the adaptation of user interaction with the resource based on the facet that is currently active includes:
providing, from the first device to the second device, user identity information that is associated with the facet of the user's identity that is currently active.
adapting user interaction with the resource at the second device based on the user identity information.

3. The machine implemented method of claim 1 wherein the providing for the adaptation of user interaction with the resource based on the facet that is currently active includes adapting user interaction with the resource at the first device based on user identity information associated with the facet of the user's identity that is currently active.

4. The machine implemented method of claim 1 wherein the electronically receiving, at a first electronic device from a second electronic device, a request associated with a resource with which a user wishes to interact includes receiving a request from a host device that the user is using to interact with the resource.

5. The machine implemented method of claim 4, wherein the request associated with a resource with which a user wishes to interact is sent to the first device in response to the user requesting access to the resource.

6. The machine implemented method of claim 1 further comprising:
receiving user identity information for different facets of the user's identity from a plurality of host devices; and
storing the user identity information from each of the plurality of host devices, different portions of the user identity information are associated with different facets of the user's identity.

7. The machine implemented method of claim 6 further comprising:
determining a subset of the user identity information that corresponds to the currently active facet of the user's identity; and
adapting user interaction with the resource based on the subset of the user identity information.

8. The machine implemented method of claim 7 wherein the adapting user interaction with the resource based on the subset of the user identity information includes controlling access to the resource based on permissions in the subset of the user identity information.

9. The machine implemented method of claim 1 wherein the determining a facet of the user's identity that is currently active based at least in part on one or more environment conditions includes applying a set of rules that are provided by the user.

10. The machine implemented method of claim 1 wherein the determining a facet of the user's identity that is currently active based at least in part on one or more environment conditions includes identifying what type of device is being used by the user to access the resource.

11. The machine implemented method of claim 1, wherein the determining a facet of the user's identity that is currently active based at least in part on one or more environment conditions includes identifying a type of communication connection being used to access the resource.

12. The machine implemented method of claim 1, wherein the determining a facet of the user's identity that is currently active based at least in part on one or more environment conditions includes identifying a time period associated with the request and applying the time period to a set of user-provided rules.

13. A machine implemented method comprising:
electronically sending, from a first electronic device to a second electronic device, a request for user identity information that is specific to an active facet of a user's identity;
receiving a set of user identity information at the first electronic device that is specific to the active facet of the of user's identity in response to the request; and
adapting user interaction with a resource with which the user is interacting with at the first electronic device based on the set of user identity information that is specific to the active facet of the user's identity.

14. The machine implemented method of claim 13 wherein the electronically sending, from a first electronic device to a second electronic device, a request for user identity information that is specific to an active facet of a user's identity includes a resource server that provides the resource sending a request for the user identity information to the second electronic device.

15. The machine implemented method of claim 13 wherein the adapting user interaction with a resource includes controlling access to the resource based on the set of user identity information that is specific to the active facet of the user's identity.

16. The machine implemented method of claim 13, further comprising:
receiving user identity information from a plurality of host devices, different portions of the user identity information are specific to different facets of the user's identity; and
storing the user identity information, different potions of the stored user identity information are associated with the different facets.

17. The machine implemented method of claim 16, further comprising:
forming the set of user identity information from the stored user identity information, at least a portion of the set of user identity information is specific to the active facet of the of user's identity; and
sending the set of user identity information to the first electronic device, the first electronic device adapts user interaction with the resource based on the set of user identity information.

18. A computer system comprising:
a processor;
one or more computer readable storage devices coupled to the processor, the one or more computer readable storage devices have stored thereon instructions which when executed on the processor cause the processor to receive user identity information from a plurality of host devices, different portions of the user identity information are specific to different facets of a user's identity; store the user identity information from each of the plurality of host devices in the one or more computer readable storage devices, different potions of the stored user identity information are associated with different facets of a user's identity; electronically receive, from either a first of the host devices or an electronic device that is being accessed by the first host device, a request for user identity information that is specific to an active facet of the user's identity; determine a facet of a user's identity that is active at the time the request is received based on one or more environment conditions; form a set of user identity information from the stored user identity information, at least a portion of the set of user identity information is specific to the facet that is determined to be active; and send the set of user identity information to either the first of the host devices or the electronic device that is being accessed by the first host device.

19. The computer system of claim 18, wherein the user identity information that is sent to either the first of the host devices or the electronic device that is being accessed by the first host device includes user identity information that was received at the computer system from a second of the plurality of host devices.

20. The computer system of claim 19, wherein the user identity information further includes baseline user identity information that is common to each of the facets of the user's identity.
